(19) United States
(12) Patent Application Publication
(10) Pub. No.: US 2020/0080367 A1
(43) Pub. Date: Mar. 12, 2020

(54) ROLLER SHADE/DRAPERY MOUNTING SYSTEM

(71) Applicant: James A. Daugaard, Port St. Lucie, FL (US)

(72) Inventor: James A. Daugaard, Port St. Lucie, FL (US)

(21) Appl. No.: 16/241,702

(22) Filed: Jan. 7, 2019

Related U.S. Application Data
(60) Provisional application No. 62/729,688, filed on Sep. 11, 2018.

(51) Int. Cl. E06B 9/24; A47H 1/04; A47H 15/02; A47H 1/13; E06B 9/42

(52) U.S. Cl. CPC E06B 9/24; A47H 1/04; E06B 2009/2452; A47H 1/13; E06B 9/42; A47H 15/02

(57) ABSTRACT

A window shade system is presented that combines the benefits of roller shades with draperies. In one arrangement a fascia having a front plate and a bottom plate includes a track positioned in the forward lower end of the fascia. The fascia is configured to be attached to a plurality of brackets. One or more roller shades having roller shade material attached to a tube are connected to the brackets. A plurality of carriers are positioned in the track and one or more draperies are attached to the plurality of carriers in the track. This arrangement presents a dual functioning window shade wherein roller shade material may be opened and closed by raising and lowering the roller shade material by rotating the tube of the roller shades raised, and the drapery shade material may be opened and closed by sliding the drapery shade material along the length of the track.

### CROSS REFERENCE TO RELATED PATENT APPLICATIONS

The present utility patent application claims priority to U.S. Provisional Patent Application No. 62/729,688 entitled “ROLLER SHADE/DRAPERY MOUNTING SYSTEM” filed on Sep. 11, 2018, which is fully incorporated by reference herein.

### FIELD OF THE DISCLOSURE

This disclosure relates generally to window shades. More specifically, and without limitation, this disclosure relates to window shades having multiple shade materials.

### BACKGROUND OF THE DISCLOSURE

Countless forms of window shades exist in the prior art. Two common types of window shades, that are of particular interest to this disclosure, include roller shades and draperies.

Roller Shades:

Roller shades are commonly known in the art. Conventional roller shades often include a tube (or rod) that is generally cylindrical in shape. A panel of shade material is connected at its upper end to the tube and includes a weighted bottom bar at the lower end of the shade material. The shade material is wrapped around the tube. An axle extends outward from each end of the tube. These axles are held by a bracket that is connected to a structure, such as a wall or ceiling often adjacent to a window. As the tube rotates in a first direction, an unwinding direction, the shade material is unwound from around the tube thereby lowering the shade material and bottom bar. As the tube rotates in a second direction, a winding direction, the shade material is wound-up around the tube thereby raising the shade material and bottom bar. In this way, the shade material moves between a fully closed (or fully lowered) position and a fully open (or fully raised) position.

Roller shades are aesthetically pleasing and provide many benefits. However, roller shades suffer from many disadvantages. That is, when using a single roller shade as a window covering the shade material must be carefully selected. That is the opacity/transparency, or how much light the shade material allows to pass through the shade material, must be carefully considered.

If the shade material is too transparent, the shade material will let too much light into the room during the day thereby reducing or eliminating the roller shade's ability to reduce light and glare inside the building. In addition, if the shade material is too transparent, it will also allow people to see into the building through the shade material at night when it is dark outside but lights are on inside the building.

In contrast, if the shade material is too opaque, the shade material will block too much light into the room during the day thereby making the inside of the building too dark and eliminating too much desirable natural light. In addition, if the shade material is too opaque, it will not allow people inside of the building to adequately see through the shade material to see what is outside, which is less than desirable.

In view of these limitations, when using a single roller shade to cover a window, users are often forced to select a shade material that works sub optimally in all situations. That is, on one hand, if they select a black-out material, or a highly opaque material, the shade material would be too dark and/or opaque at times, it would not let enough light into the building at times, and it would not allow people inside the building to adequately see outside through the shade material. On the other hand, if they select a sheer material, or a highly transparent material, the shade material would be too transparent at times, it would let too much light into the building at times, and it would allow people outside the building at night to see into the building through the sheer material when the lights are on.

To split the difference between, users often select a shade material with an opacity somewhere in-between these two extremes, meaning that the roller shade does not block enough light at times, blocks too much light at times, is too transparent at times and is not transparent enough at times.

As such, using a single roller shade with a single panel of shade material provides a sub-optimal window shade.

Draperies:

Draperies are commonly known in the art. Conventional draperies often include a track (or rail) that receives and guides a carrier of some form. A panel of shade material is connected at its upper end to the carriers which hangs vertically down from the track and carriers. The shade material is opened and closed by sliding the shade material along the lateral length of the track. In this way, the shade material moves between a fully closed (or fully deployed) position and a fully open (or fully retracted) position.

Draperies are aesthetically pleasing and provide many benefits. However, like roller shades, draperies suffer from many disadvantages. That is, when using a drapery as a window covering the shade material must be carefully selected. That is the opacity/transparency, or how much light the shade material allows to pass through the shade material, must be carefully considered.

If the shade material is too transparent, the shade material will let too much light into the room during the day thereby reducing or eliminating the drapery's ability to reduce light and glare inside the building. In addition, if the shade material is too transparent, it will also allow people to see into the building through the shade material at night when it is dark outside but lights are on inside the building.

In contrast, if the shade material is too opaque, the shade material will block too much light into the room during the day thereby making the inside of the building too dark and eliminating too much desirable natural light. In addition, if the shade material is too opaque, it will not allow people inside of the building to adequately see through the shade material to see what is outside, which is less than desirable.

In view of these limitations, when using a single drapery to cover a window, users are often forced to select a shade material that works sub optimally in all situations. That is, on one hand, if they select a black-out material, or a highly opaque material, the shade material would be too dark and/or opaque at times, it would not let enough light into the building at times, and it would not allow people inside the building to adequately see outside through the shade material. On the other hand, if they select a sheer material, or a highly transparent material, the shade material would be too transparent at times, it would let too much light into the building at times, and it would allow people outside the building at night to see into the building through the sheer material when the lights are on.

To split the difference between, users often select a shade material with an opacity somewhere in-between these two extremes, meaning that the drapery does not block enough light at times, blocks too much light at times, is too transparent at times and is not transparent enough at times.

As such, using a single drapery with a single panel of shade material provides a sub-optimal window shade.

Therefore, for all of the reasons stated above, and all of the reasons stated below, there is a need in the art for an improved window shade system that cures the deficiencies of roller shades and draperies.

As such, an objective of the disclosure is to provide a window shade system that improves upon the prior art.

Another objective of the disclosure is to provide a window shade system that provides the benefits of a roller shade.

Yet another objective of the disclosure is to provide a window shade system that does not suffer from the disadvantages of a roller shade.

Another objective of the disclosure is to provide a window shade system that provides the benefits of a drapery.

Yet another objective of the disclosure is to provide a window shade system that does not suffer from the disadvantages of a drapery.

Another objective of the disclosure is to provide a window shade system that combines the benefits of a roller shade and a drapery.

Yet another objective of the disclosure is to provide a window shade system that eliminates the deficiencies of roller shades and draperies.

Another objective of the disclosure is to provide a window shade system that is easy to install.

Yet another objective of the disclosure is to provide a window shade system that is easy to use.

Another objective of the disclosure is to provide a window shade system that that is simple to install.

Yet another objective of the disclosure is to provide a window shade system that is simple to use.

Another objective of the disclosure is to provide a window shade system that is relatively inexpensive.

Yet another objective of the disclosure is to provide a window shade system that can be used with practically any roller shade.

Another objective of the disclosure is to provide a window shade system that can be used with practically any brackets.

Yet another objective of the disclosure is to provide a window shade system that can be used with practically any window.

Another objective of the disclosure is to provide a window shade system that is aesthetically pleasing.

Yet another objective of the disclosure is to provide a window shade system that provides improved functionality.

Another objective of the disclosure is to provide a window shade system that facilitates the selection of optimum shade material for use with the window shade system.

Yet another objective of the disclosure is to provide a window shade system that has a small and unobtrusive stature when installed.

Another objective of the disclosure is to provide a window shade system that has a sleek appearance.

Yet another objective of the disclosure is to provide a window shade system that is safe to use.

Another objective of the disclosure is to provide a window shade system that allows for use of a drapery with a roller shade but does not require use of a drapery with a roller shade.

Yet another objective of the disclosure is to provide a window shade system that allows for use of a roller shade with a drapery but does not require use of a roller shade with a drapery.

Another objective of the disclosure is to provide a window shade system that can be used to modify existing roller shades to include add a drapery.

Yet another objective of the disclosure is to provide a window shade system that efficiently allows for the use of a sheer material as well as an opaque material in a single window shade system.

Another objective of the disclosure is to provide a window shade system that is intuitive to use.

Yet another objective of the disclosure is to provide a window shade system that strong and robust.

Another objective of the disclosure is to provide a window shade system that can be used in many applications.

Yet another objective of the disclosure is to provide a window shade system that provides unique functionality.

Another objective of the disclosure is to provide a window shade system that saves time.

Yet another objective of the disclosure is to provide a window shade system that is pleasing to use.

Another objective of the disclosure is to provide a window shade system that has a compact size.

Yet another objective of the disclosure is to provide a window shade system that can be used in any length.

Another objective of the disclosure is to provide a window shade system that can be used in any height.

Yet another objective of the disclosure is to provide a window shade system that has a long useful life.

Another objective of the disclosure is to provide a window shade system that is high quality.

Yet another objective of the disclosure is to provide a window shade system that can be used with practically any shade material.

Another objective of the disclosure is to provide a window shade system that eliminates the need to install two separate window shades.

These and other objects, features, or advantages of the disclosure will become apparent from the specification, figures and claims

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front elevational view of a roller shade/drapery mounting system constructed in accordance with the principles of the present disclosure.

FIG. 2 is an enlarged showing of a portion of the system taken at circle 2 of FIG. 1

FIG. 3 is an end elevational view taken at line 3-3 of FIG. 2.

FIG. 4 is an enlarged exploded view of an end support and fascia of the prior figures.

FIG. 5 is a bottom view of the fascia taken at line 5-5 of FIG. 4.

FIG. 6 is an end elevational view of the fascia taken at line 6-6 of FIG. 5.

FIG. 7 is a rear-top-right side perspective view of a roller shade and drapery window shade system, the view showing a pair of brackets positioned in opposing spaced alignment and forming a hollow interior that faces one another, the view showing a center bracket positioned between the opposing brackets, the view showing a roller shade assembly positioned within the hollow interior of brackets and center bracket and attached to the brackets, the view showing a fascia attached to the forward side and bottom side of the brackets and center bracket, the fascia having a track positioned at the forward lower side of the fascia at the intersection of the front plate and bottom plate of the fascia, the view showing a plurality of carriers positioned within the track that are attached to a drapery shade material that hangs down from the plurality of carriers.

FIG. 8 is a right side elevation view of the roller shade and drapery window shade system shown in FIG. 7, the view showing the fascia installed onto the bracket with the upper connection member of the front plate of the fascia installed within the groove of the upper receiver of the bracket, the view showing the interior surface of the front plate of the fascia in flat and flush engagement with the forward face of the front wall of the bracket, the view showing the lower connection member of the bottom plate of the fascia installed within the groove of the lower receiver of the bracket, the view showing the upper surface of the bottom plate of the fascia in a flat and flush engagement with the bottom surface of the bottom wall of the bracket, the view showing the track of the fascia positioned within the cut out section on the forward lower side of the bracket, the view showing carriers positioned within the hollow interior of the track with a roller assembly positioned within the hollow interior, an arm extending through the slot and a connector connecting to the upper edge of the drapery shade material, the view showing a center bracket installed between the end brackets that are positioned adjacent the outward ends of the fascia.

FIG. 9 is a right side elevation section view of the roller shade and drapery window shade system shown FIG. 8, the view additionally showing the tube of the roller shade assembly positioned within the hollow interior of the bracket, the view showing roller shade material wrapped around the tube of the roller shade material, the view showing the roller shade material in a deployed or lowered or closed state.

FIG. 10 is a right side rear exploded perspective view of the roller shade and drapery window shade system shown in FIGS. 7-9, the view showing the fascia installed onto the bracket, the view showing a plurality of carriers exploded out from the hollow interior of the track with a roller assembly, an arm and a connector connecting to the upper edge of the drapery shade material, the view showing the drapery shade material in a deployed or closed position with the plurality of carriers spaced along the upper edge of the drapery shade material, the view showing the roller shade assembly exploded out of the hollow interior of the bracket, the view showing roller shade material wrapped around the tube of the roller shade material, the view showing the roller shade material in a deployed or lowered or closed state, the view showing the axle holder positioned in the interior surface of the end wall of the bracket.

FIG. 11 is a rear-top-right side perspective view of a roller shade and drapery window shade system shown in FIG. 7 with the carriers and drapery shade material removed.

FIG. 12 is a top elevation view of the fascia shown in FIGS. 7-11.

FIG. 13 is a rear elevation view of the fascia shown in FIGS. 7-11.

FIG. 14 is a bottom elevation view of the fascia shown in FIGS. 7-11.

FIG. 15 is a front elevation view of the fascia shown in FIGS. 7-11.

FIG. 16 is a right side elevation view of the fascia shown in FIGS. 7-11.

FIG. 17 is a left side elevation view of the fascia shown in FIGS. 7-11.

FIG. 18 is a top-right-rear perspective view of the fascia shown in FIGS. 7-11.

FIG. 19 is a rear-top-right side perspective view of a roller shade and drapery window shade system shown in FIG. 11 with the tube of the roller shade assembly removed, the view showing the bottom wall of the bracket positioned just forward of the lower connection member in the upper surface of the bottom plate of the fascia.

FIG. 20 is a rear-top-right side exploded perspective view of a roller shade and drapery window shade system shown in FIG. 19.

FIG. 21 is a top elevation view of a bracket shown in FIGS. 7-11.

FIG. 22 is a rear elevation view of a bracket shown in FIGS. 7-11.

FIG. 23 is a bottom elevation view of a bracket shown in FIGS. 7-11.

FIG. 24 is a front elevation view of a bracket shown in FIGS. 7-11.

FIG. 25 is an interior side elevation view of a bracket shown in FIGS. 7-11.

FIG. 26 is an exterior side elevation view of a bracket shown in FIGS. 7-11.

FIG. 27 is a perspective view of the interior side of a bracket shown in FIGS. 7-11.

FIG. 28 is a top elevation view of a center bracket shown in FIGS. 7-11.

FIG. 29 is a rear elevation view of a center bracket shown in FIGS. 7-11.

FIG. 30 is a bottom elevation view of a center bracket shown in FIGS. 7-11.

FIG. 31 is a front elevation view of a center bracket shown in FIGS. 7-11.

FIG. 32 is a right side elevation view of a center bracket shown in FIGS. 7-11.

FIG. 33 is a left side elevation view of a center bracket shown in FIGS. 7-11.

FIG. 34 is a top-right-rear perspective view of a center bracket shown in FIGS. 7-11.

### SUMMARY OF THE DISCLOSURE

A window shade system is presented that combines the benefits of roller shades with draperies. In one arrangement a fascia having a front plate and a bottom plate includes a track positioned in the forward lower end of the fascia. The fascia is configured to be attached to a plurality of brackets. One or more roller shades having roller shade material attached to a tube are connected to the brackets. A plurality of carriers are positioned in the track and one or more draperies are attached to the plurality of carriers in the track. This arrangement presents a dual functioning window shade wherein roller shade material may be opened and closed by raising and lowering the roller shade material by rotating the tube of the roller shades raised, and the drapery shade material may be opened and closed by sliding the drapery shade material along the length of the track.

### DETAILED DESCRIPTION

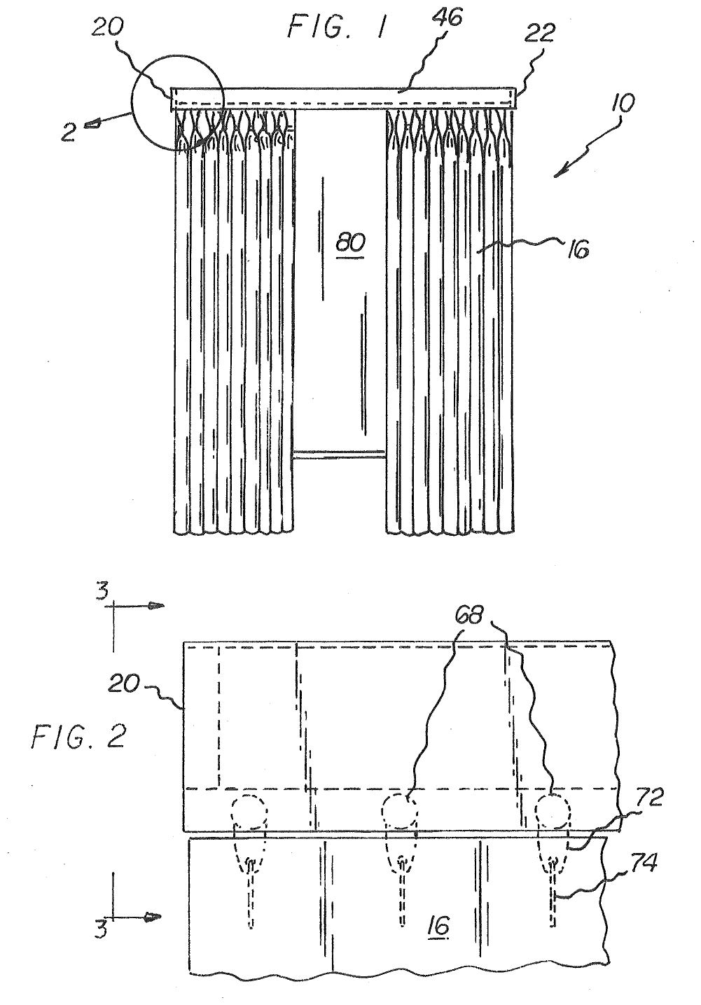

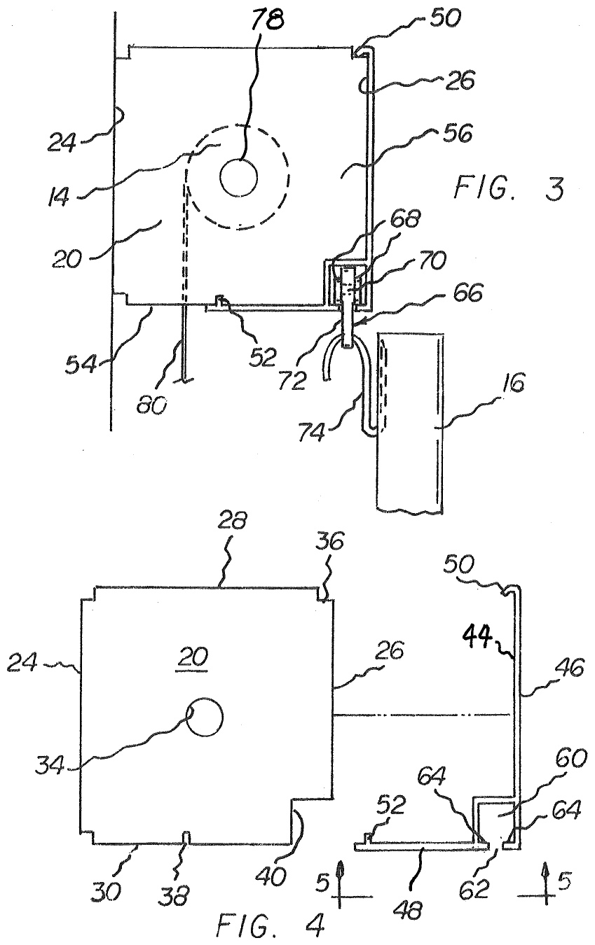

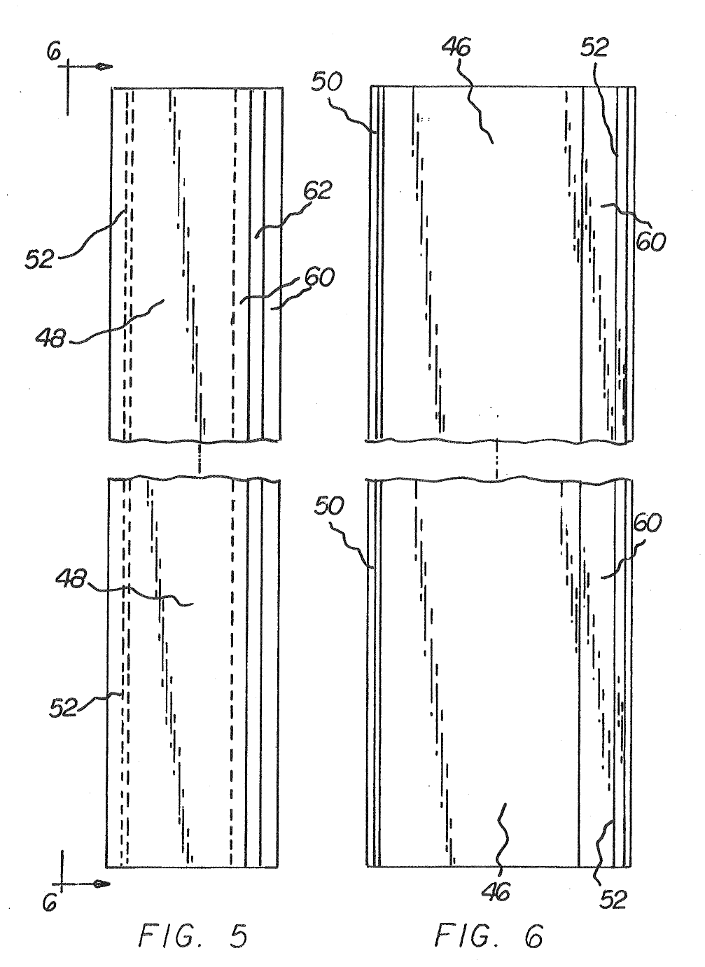

FIGS. 1-6:

With reference to FIGS. 1-6, in view of the disadvantages inherent in the known types of mounting systems for roller shades and drapery now present in the prior art, the disclosure provides an improved roller shade/drapery mounting system 10 integrating both components into one uniform system. As such, the general purpose of the disclosure, which will be described subsequently in greater detail, is to provide a new and improved roller shade/drapery mounting system 10 and method which has all the advantages of the prior art and none of the disadvantages.

To attain this, from a broad perspective, two support plates 20, 22 are provided. Each support plate 20, 22 has an interior edge 24, an exterior edge 26, an upper edge 28, and a lower edge 30. An upper recess 36 is formed in an upper exterior region of each of the support plates 20, 22. A lower recess 38 is formed in a central region of the lower edge 30 of each of the support plates 20, 22. A cutout 40 is formed in a lower exterior region of each of the support plates 20, 22.

A fascia 44 with front plate 46 and bottom plate 48 is next provided. The fascia 44 has ends at the support plates 20, 22. The front plate 46 has an upper projection 50 positioned in the upper recess 36 of each support plate 20, 22. The bottom plate 48 has a lower projection 52 positioned in the lower recess 38 of each support plate 20, 22 spaced from the interior edge 24 to form a major passageway 54. A major chamber 56 is formed rearwardly of the front plate 46 and upwardly of the bottom plate 48.

Next provided is a minor chamber 60 formed rearwardly of the front plate 46 and upwardly of the bottom plate 48. A minor passageway 62 is formed in the minor chamber 60 bounded by tracks 64.

In this respect, before explaining at least one embodiment of the disclosure in detail, it is to be understood that the disclosure is not limited in its application to the details of the construction shown and to the arrangements of the components set forth in the following description or illustrated in the drawings. The disclosure is capable of other embodiments and of being practiced and carried out in various and additional ways. Also, it is to be understood that the phraseology and terminology employed herein are for the purpose of descriptions and should not be regarded as limiting. As such, those skilled in the art will appreciate that the conception, upon which this disclosure is based, may readily be utilized as a basis for the designing of other structures, methods and systems for carrying out the several purposes of the disclosure. It is important, therefore, that the disclosure be regarded as including such equivalent constructions insofar as they do not depart from the spirit and scope of the disclosure.

With reference now to the drawings FIGS. 1-6, and in particular to FIG. 1 thereof, the new and improved roller shade/drapery mounting system 10 embodying the principles and concepts of the disclosure and generally designated by the reference numeral 10 will be described.

In the arrangement shown, as one example, roller shade/drapery mounting system 10 is comprised of a plurality of components. In their broadest context such include two support plates 20, 22, a fascia 44, a major chamber 56, and a minor chamber 60. Such components are individually configured and correlated with respect to each other so as to attain the desired objectives.

In the arrangement shown, as one example, roller shade/drapery mounting system 10 is a system 10 for supporting and repositioning both a roller shade 14 and drapery 16. A left support plate 20 and a similarly configured right support plate 22 are provided. The left support plate 20 and right support plate 22 are laterally spaced a fixed distance in vertical planes. The left support plate 20 and right support plate 22 each have an interior edge 24 and a parallel exterior edge 26. The left support plate 20 and right support plate 22 each have an upper edge 28 and a parallel lower edge 30.

A circular hole 34 is formed in a central region of each of the support plates 20, 22. An upper recess 36 is formed in an upper exterior region of each of the support plates 20, 22. A lower recess 38 is formed in a central region of the lower edge 30 of each of the support plates 20, 22. A square cutout 40 is formed in a lower exterior region of each of the support plates 20, 22.

Next provided is a fascia 44 in an L-shaped configuration with a front plate 46 and a bottom plate 48. The fascia 44 is elongated and has a left end positioned at the left support plate 20. The fascia 44 has a right end positioned at the right support plate 22. The front plate 46 is positioned in contact with the exterior edges 26 of the left support plate 20 and right support plate 22. The front plate 46 has an upper projection 50 positionable in the upper recesses 36 of each support plate 20, 22. The bottom plate 48 has a lower projection 52 positionable in the lower recesses 38 of the support plates 20, 22 at a location spaced from the interior edge 24 to form a major passageway 54. A major chamber 56 is formed rearwardly of the front plate 46 and upwardly of the bottom plate 48.

A minor chamber 60 is formed in the major chamber 56 rearwardly of the front plate 46 and upwardly of the bottom plate 48. The minor chamber 60 is bounded exteriorly by the front plate 46. The minor chamber 60 is bounded below by the bottom plate 48. A minor passageway 62 is formed in the minor chamber 60. The minor passageway 62 is bounded by tracks 64.

In the arrangement shown, as one example, a plurality of roller assemblies 66 are positioned within the minor chamber 60. Each of the plurality of roller assemblies 66 have two rollers 68 with an axle 70 there between. A plurality of couplers 72 have an upper end above the bottom plate 48 rotatably receiving an associated axle 70. Each coupler 72 has a lower end with an aperture beneath the bottom plate 48. A plurality of hooks 74 are further provided. Each hook 74 has a first end coupled to an associated aperture of an associated coupler 72. Each hook 74 has a second end coupled to an associated region of the drapery 16.

In the arrangement shown, as one example, roller shade 14 has a spool 78 with opposed ends supported in the support plates 20, 22. The roller shade 14 has a depending section 80 extending downwardly through the major passageway 54.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

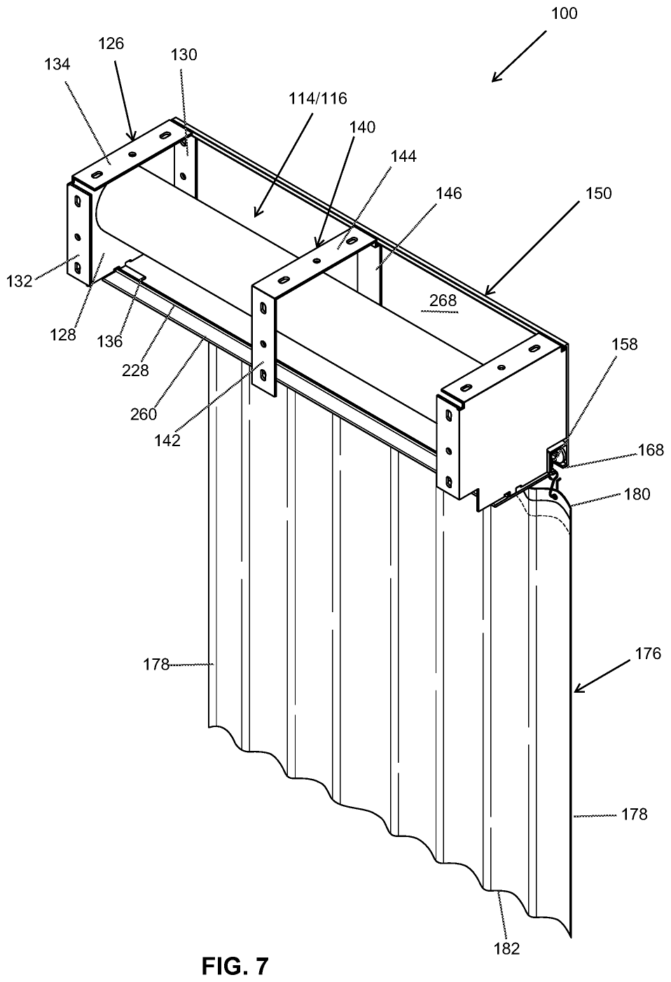

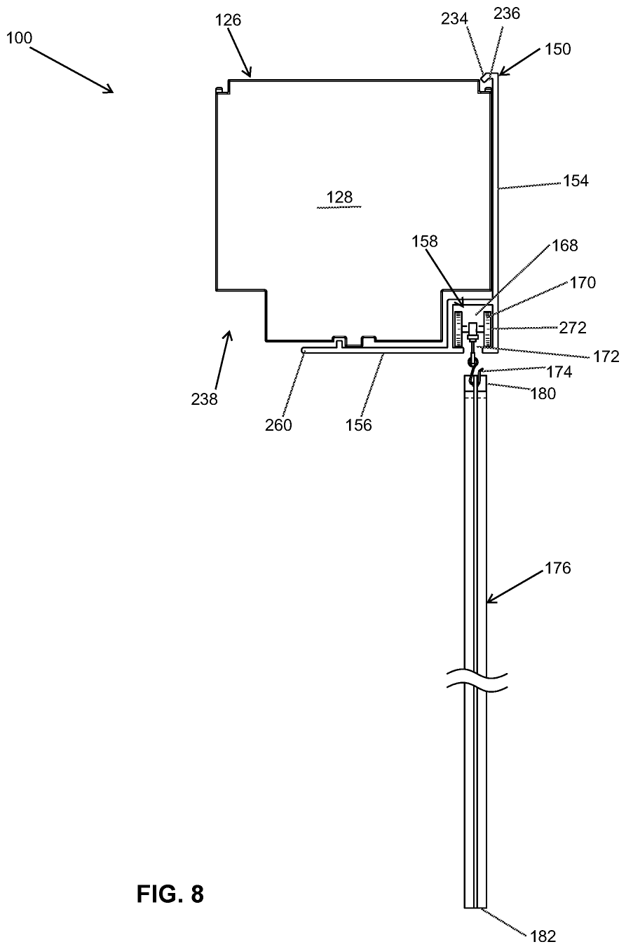

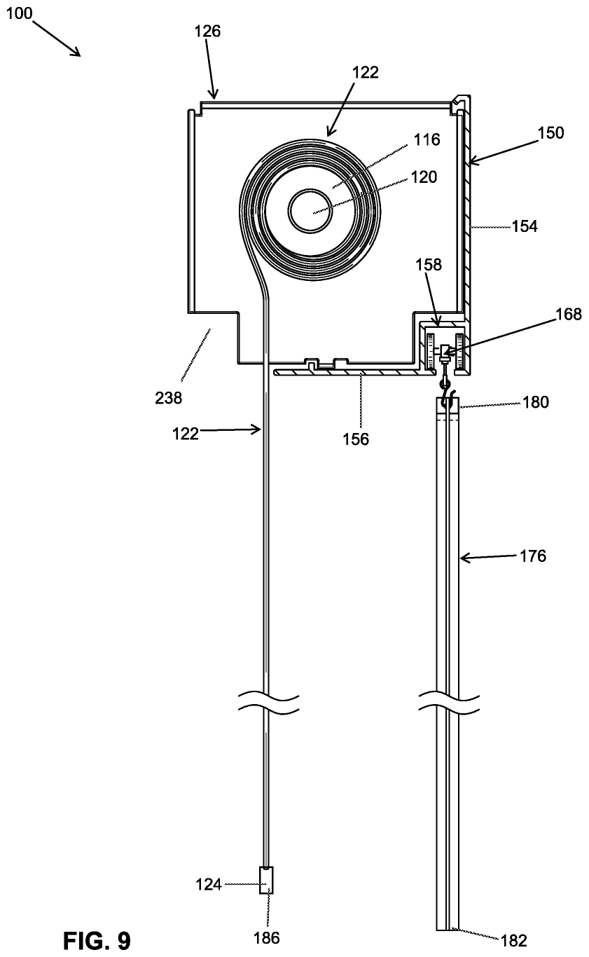

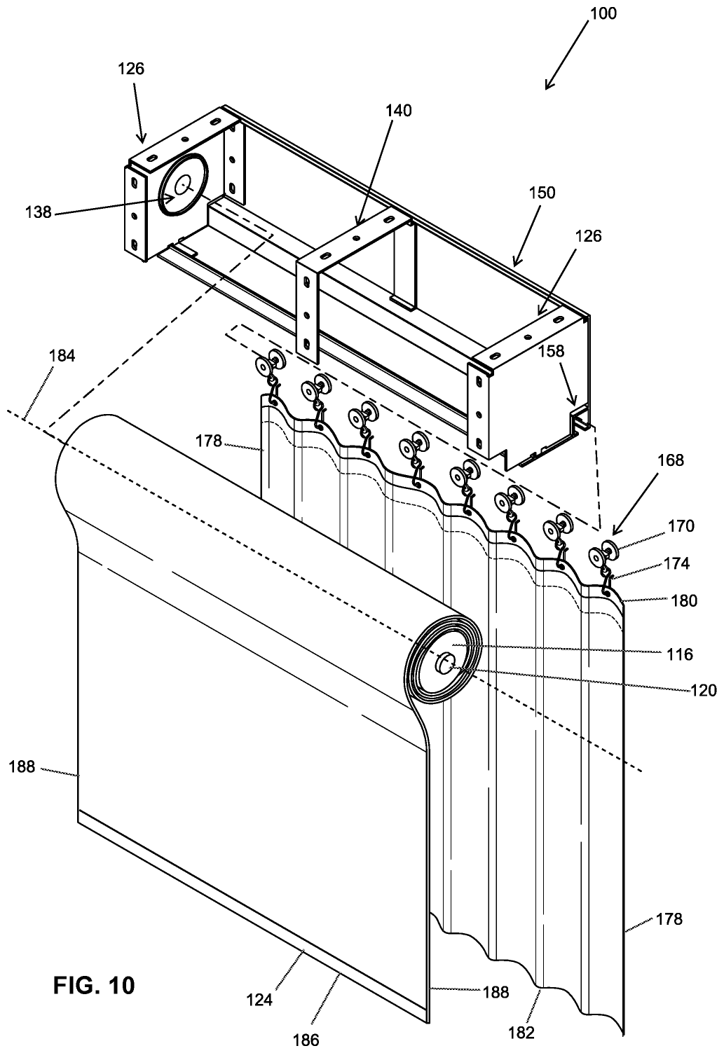

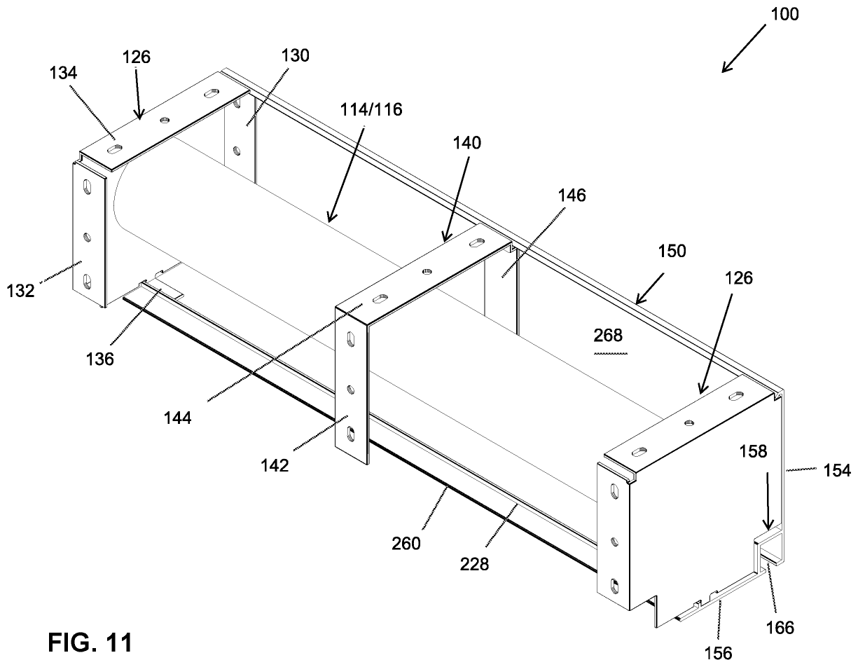

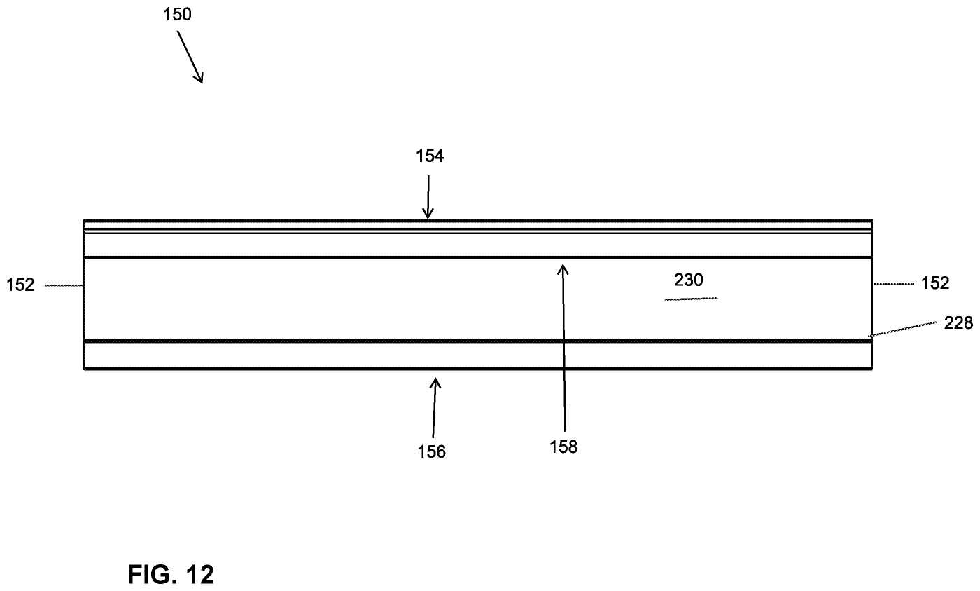

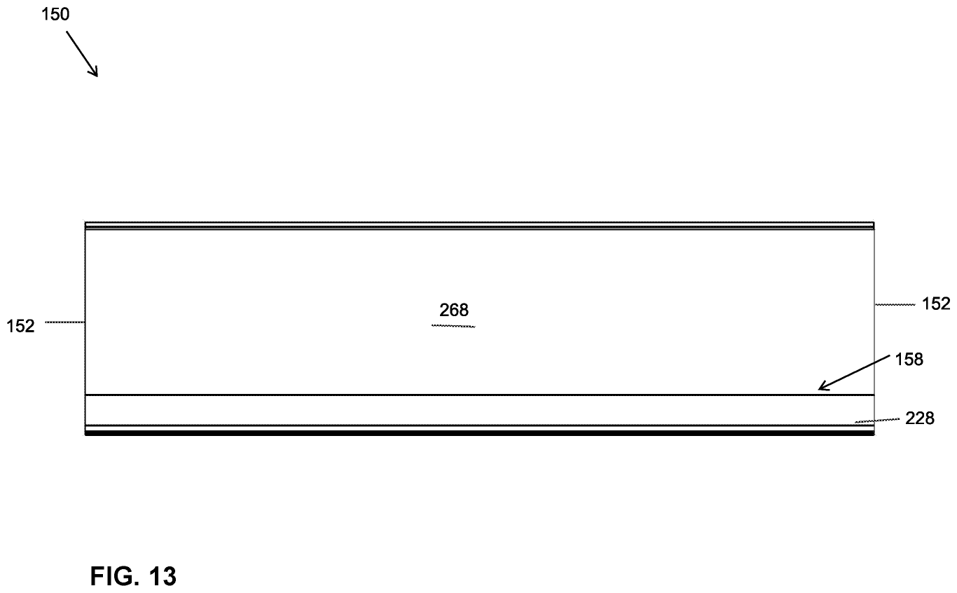

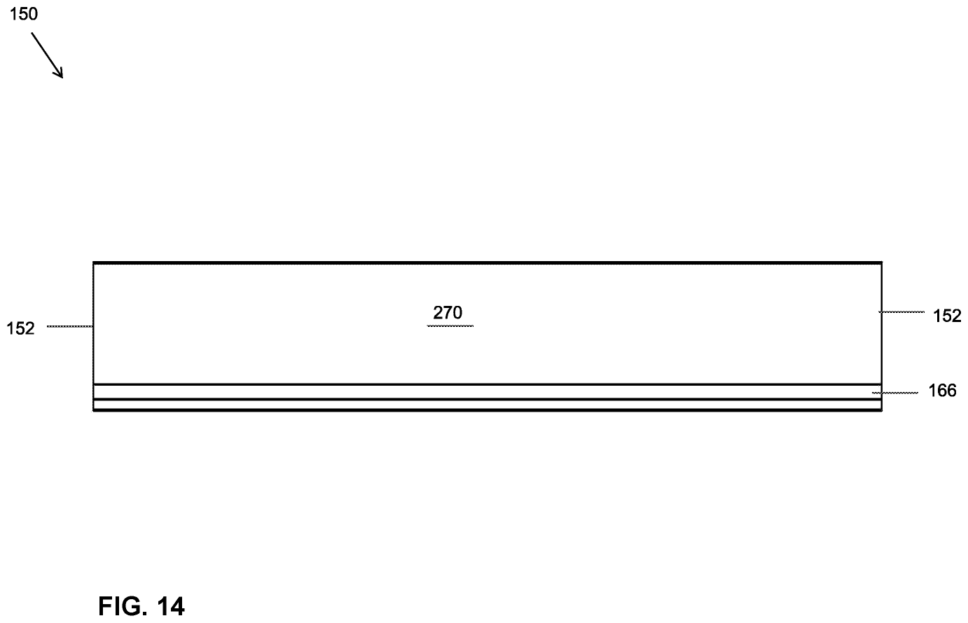

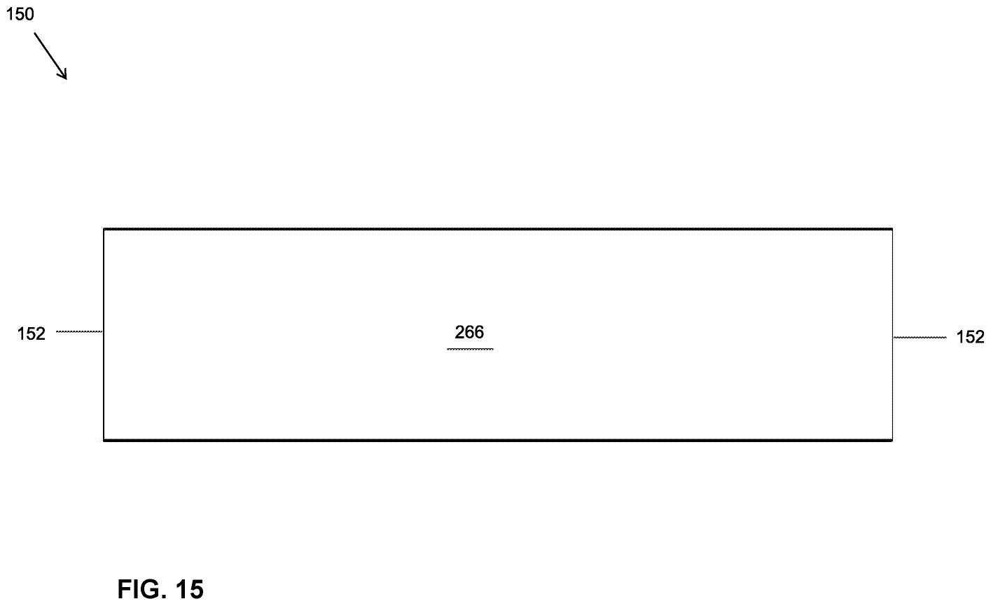

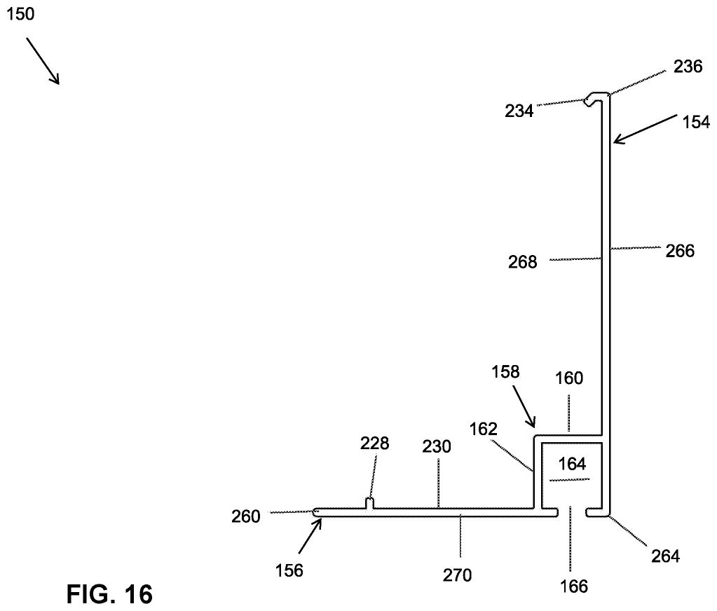

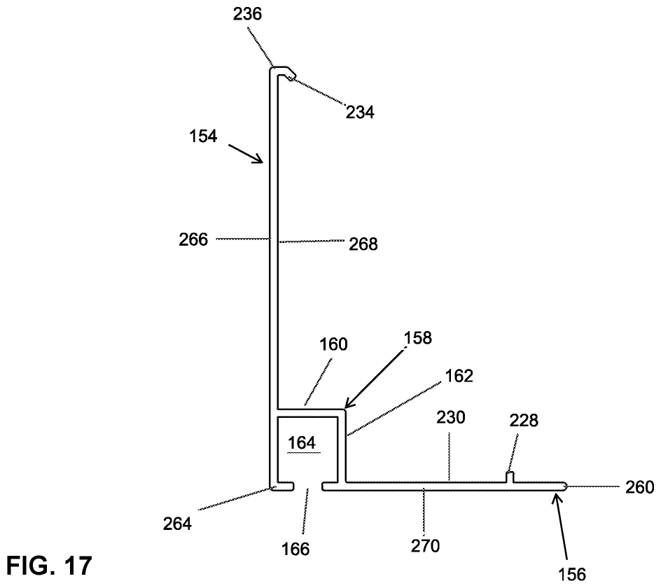

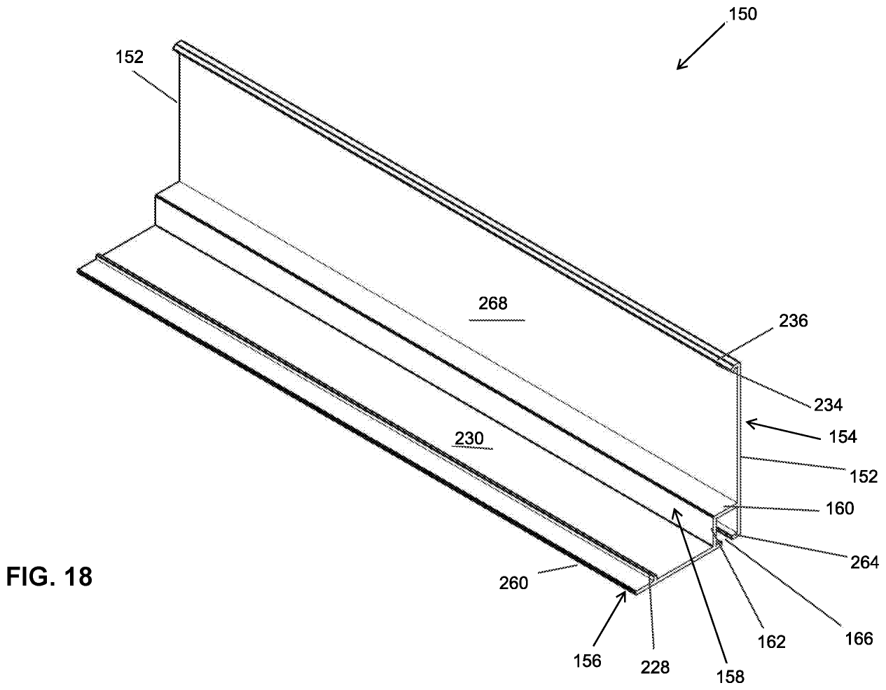

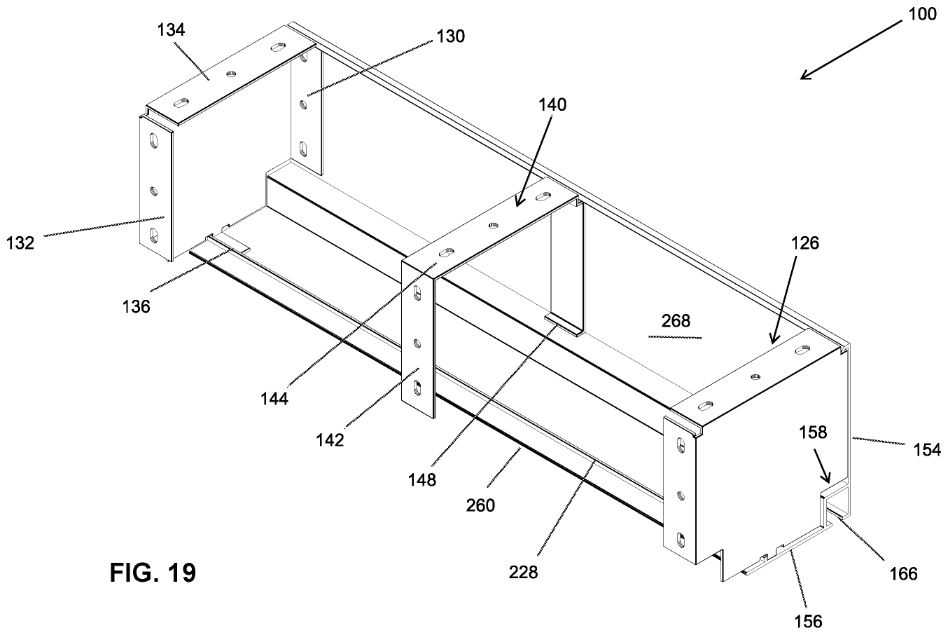

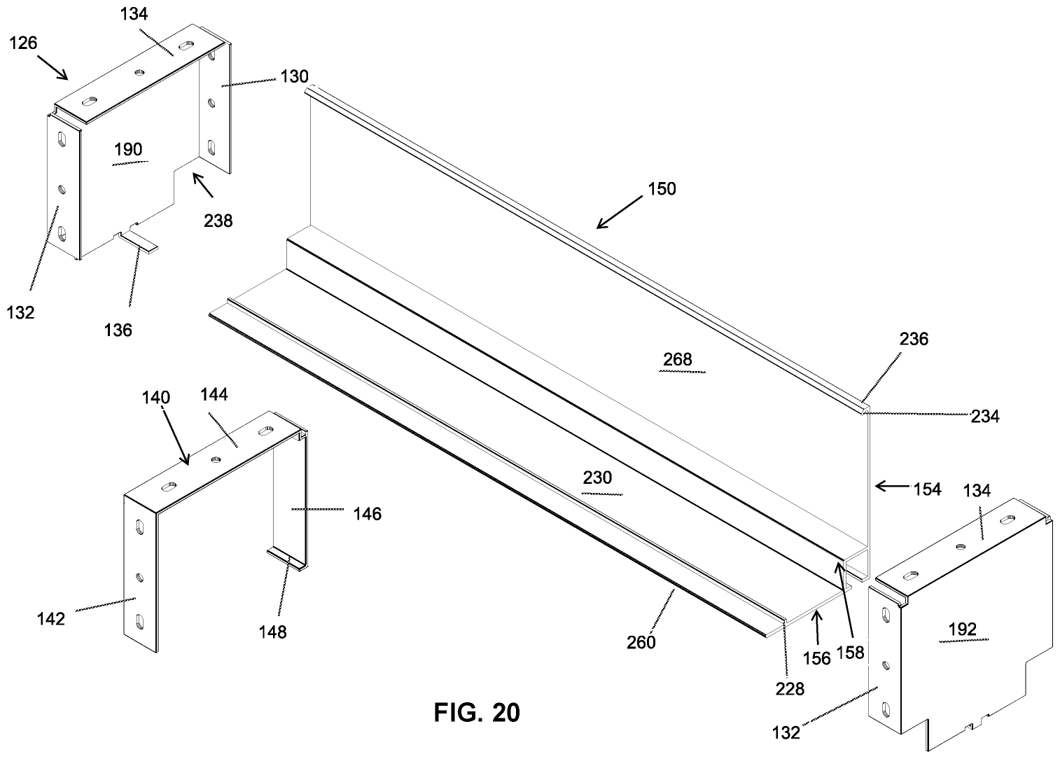

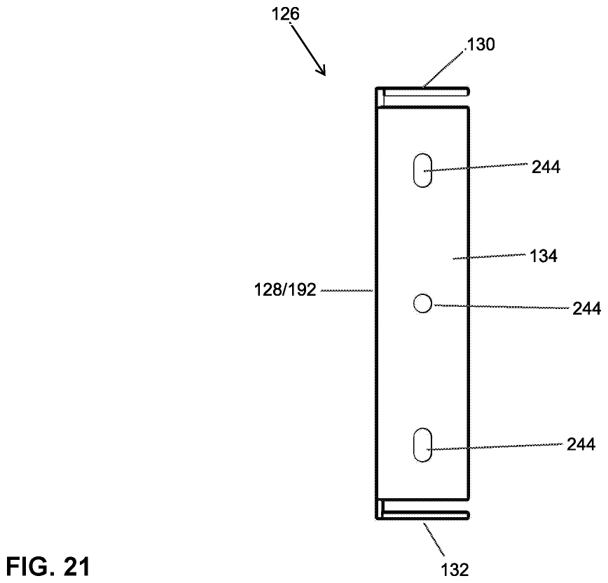

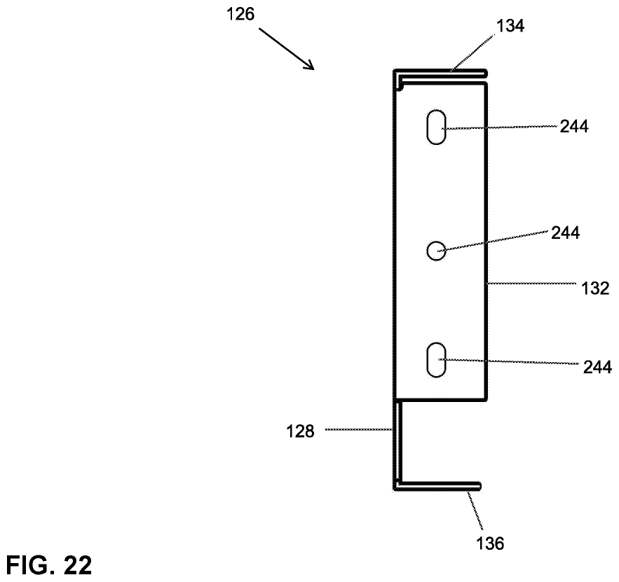

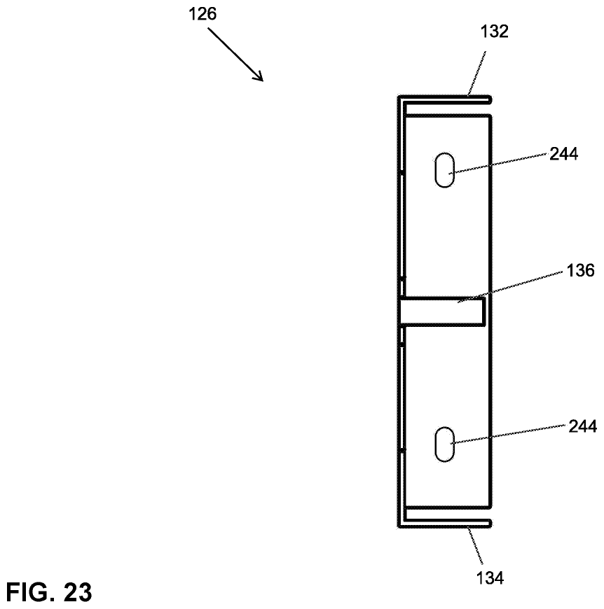

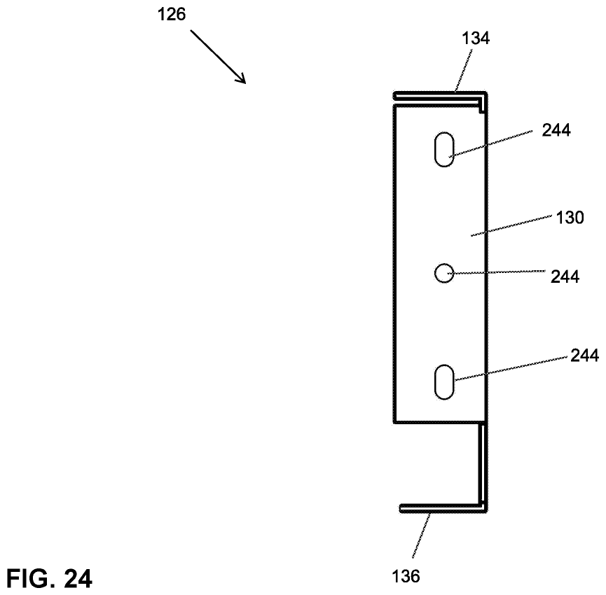

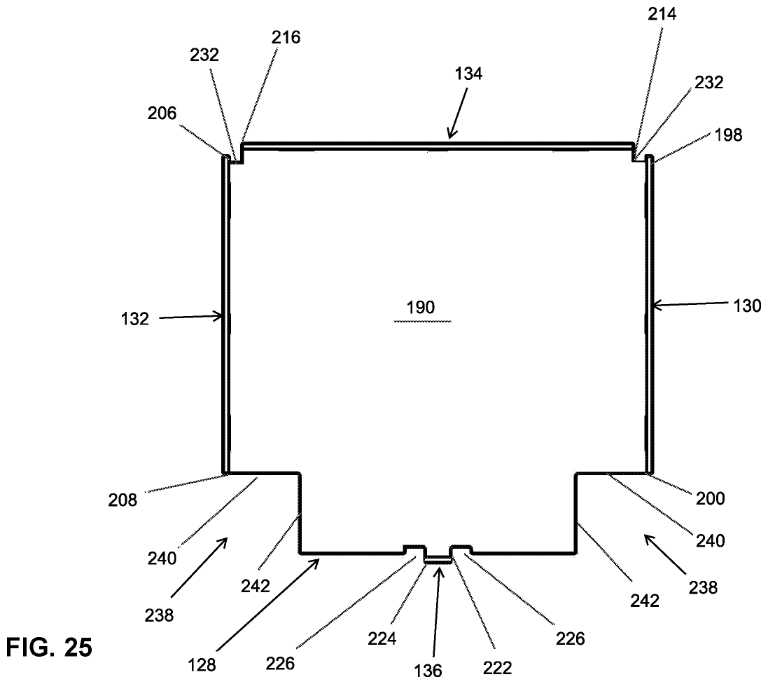

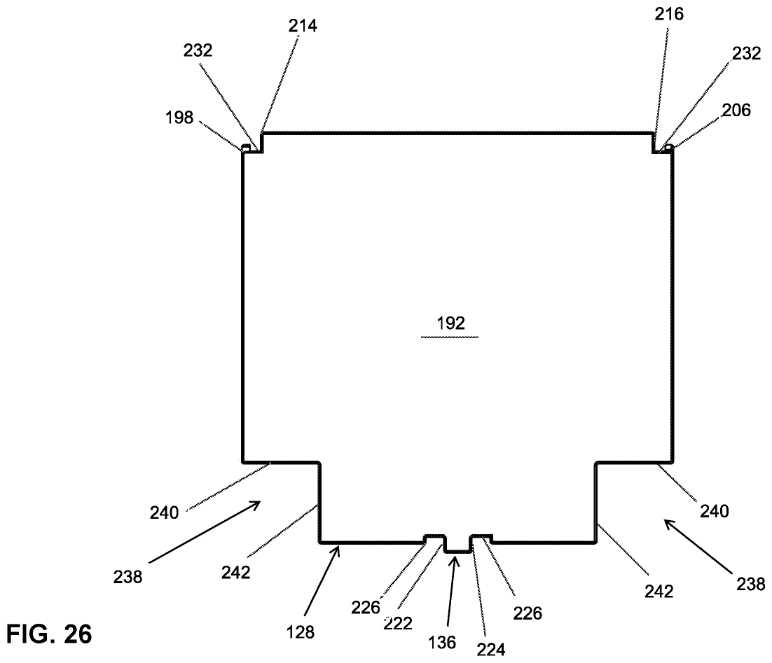

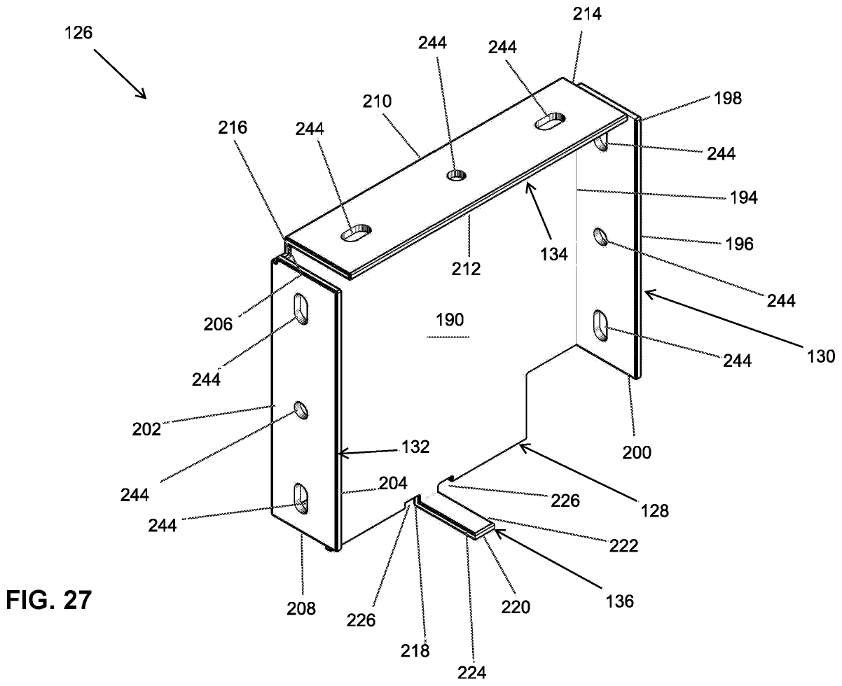

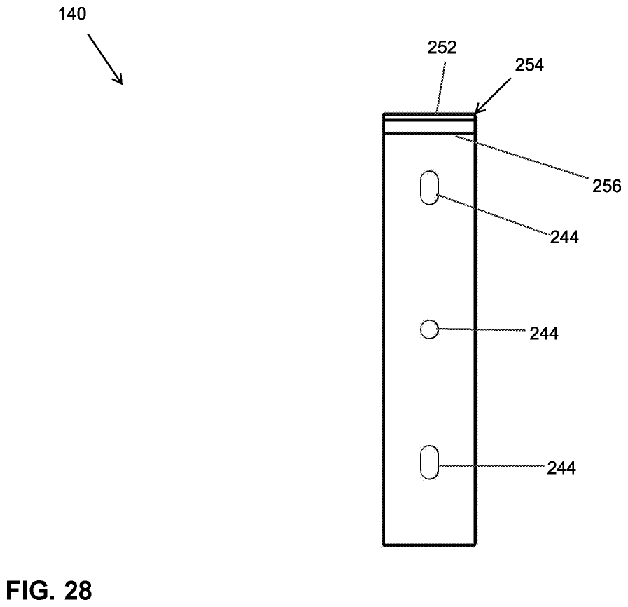

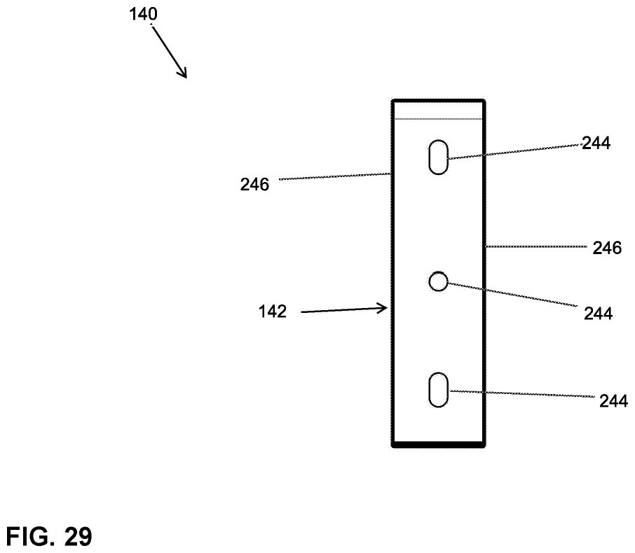

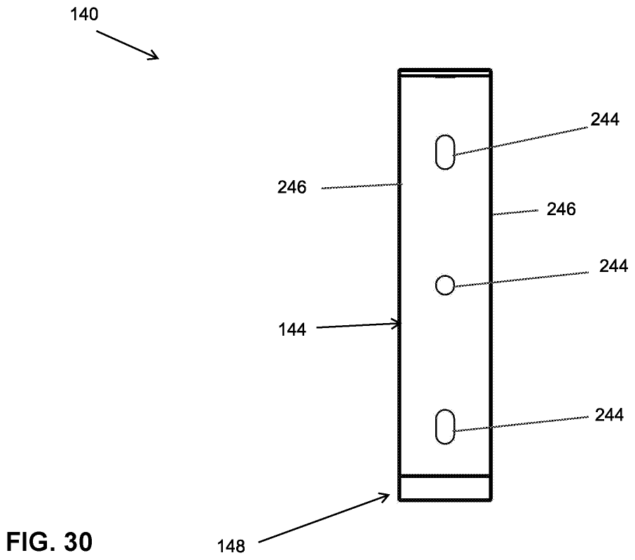

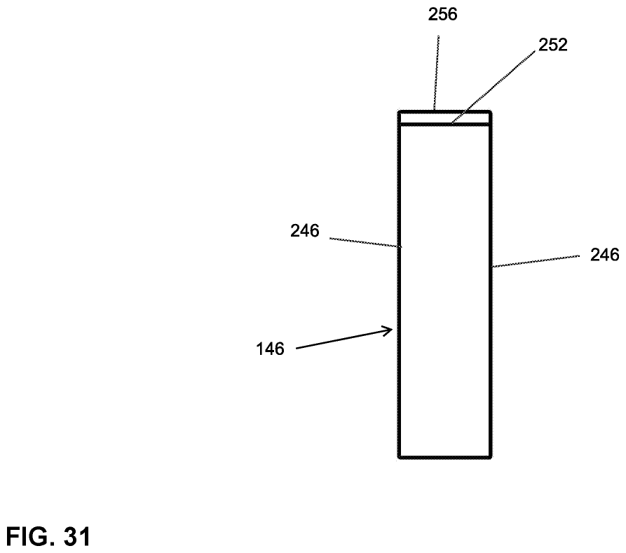

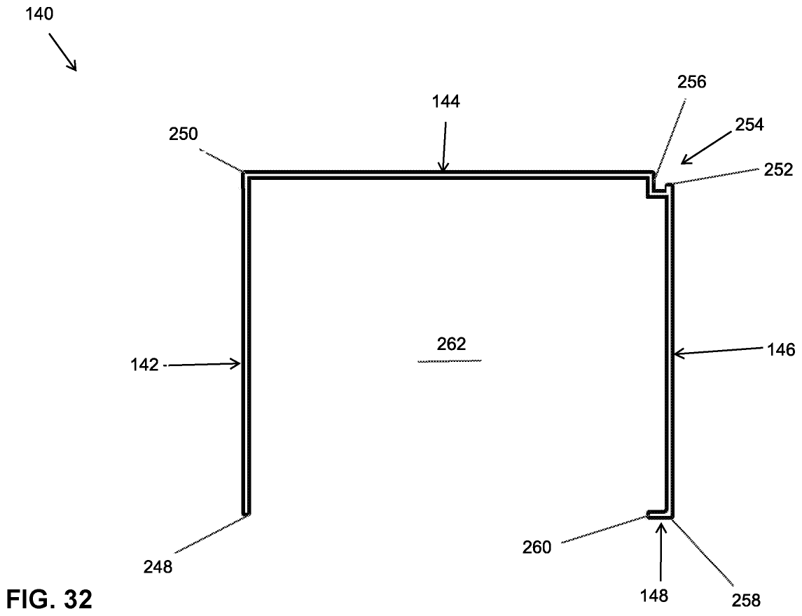

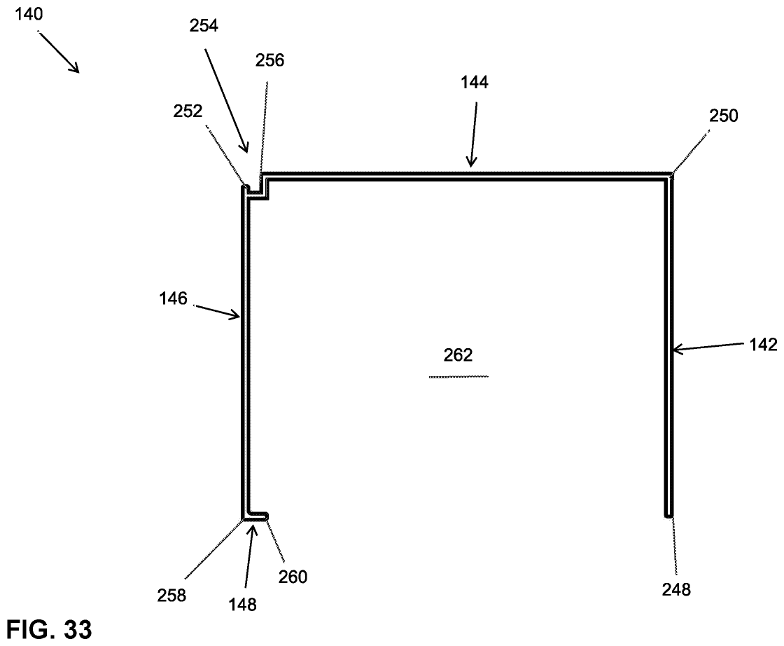

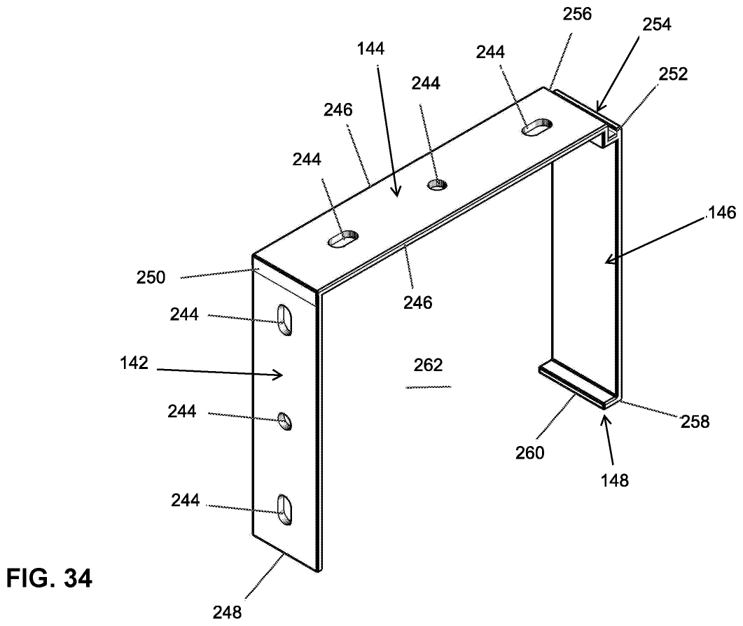

FIGS. 7-34:

With reference to FIGS. 7-34, in the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides, left, right, and the like are referenced according to the views, pieces, parts, components and figures presented. It should be understood, however, that the terms are used only for purposes of description, and are not intended to be used as limitations. Accordingly, orientation of an object or a combination of objects may change without departing from the scope of the disclosure.

System:

With reference to FIGS. 7-34, a roller shade and drapery window shade system 100 (or simply system 100) is presented. The roller shade and drapery window shade system 100 is formed of any suitable size, shape and design and is configured to facilitate the incorporation of the benefits of roller shades and draperies in a single system in a convenient, compact, easy to use, safe, aesthetically pleasing and relatively inexpensive package. In the arrangement shown, as one example, the roller shade and drapery window shade system 100 has a front side 102, a back side 104, a left side 106, a right side 108, a top side 110, a bottom side 112. In the arrangement shown, as one example, roller shade and drapery window shade system 100 includes a roller shade assembly 114 having a tube 116 that extends a length between an opposing ends 118, an axle 120 connected to each end 118, roller shade material 122 connected to the tube 116 and a bottom bar 124 connected to the roller shade material 122, among other components and features. In the arrangement shown, as one example, roller shade and drapery window shade system 100 include a pair of opposing brackets 126 having an end wall 128, a front wall 130, a rear wall 132, a top wall 134, a bottom wall 136, and an axle holder 138, among other components and features. In the arrangement shown, as one example, roller shade and drapery window shade system 100 include a center bracket 140 having a rear wall 142, a top wall 144, a front wall 146 and a bottom wall 148, among other components and features. In the arrangement shown, as one example, roller shade and drapery window shade system 100 includes a fascia 150 extending a length between opposing ends 152 and having a front plate 154, a bottom plate 156 and a track 158 having a top wall 160, a rear wall 162, a hollow interior 164 and a slot 166, among other components and features. In the arrangement shown, as one example, roller shade and drapery window shade system 100 includes a plurality of carriers 168 having a roller assembly 170, an arm 172 and a connector 174, among other components and features. In the arrangement shown, as one example, roller shade and drapery window shade system 100 includes a drapery shade material 176 extending a width between opposing sides 178 and extending a height between an upper end 180 and a lower end 182, among other components and features.

Roller Shade Assembly:

In the arrangement shown, as one example, roller shade and drapery window shade system 100 includes one or more roller shade assemblies 114. Roller shade assembly 114 is formed of any suitable size, shape and design and is configured to facilitate the vertical opening and closing of roller shade material 122 by rotation of a tube 116.

In the arrangement shown, as one example, roller shade assembly 114 includes a tube 116. Tube 116 is formed of any suitable size, shape and design and is configured to facilitate support of roller shade material 122 as well as facilitate opening and closing of roller shade material 122 by rotation of tube 116. In the arrangement shown, as one example, tube 116 is formed of a generally cylindrical member having a generally cylindrical exterior surface. Tube 116 may be a solid rod or alternatively tube 116 may have a hollow interior.

In the arrangement shown, as one example, tube 116 extends a lateral length between opposing ends 118. In the arrangement shown, as one example, an axle 120 is connected to each end 118 of tube 116. Axles 120 themselves are formed of any suitable size, shape and design and are configured to connect to brackets 126 adjacent each end 118 of tube 116. In this way, connection of axles 120 to brackets 126 facilitates support of tube 116. In the arrangement shown, tube 114 rotates around an axis of rotation 184 that extends through the approximate middle of tube 114 from end 118 to end 118 and through the approximate center of axles 120.

In the arrangement shown, as one example, roller shade assembly 114 includes roller shade material 122. Roller shade material 122 is formed of any suitable size, shape and design and is configured to be raised and lowered, opened and closed, by rotation of tube 116 while providing an aesthetically pleasing visual appearance while allowing a desirable amount of light into the building. In the arrangement shown, as one example, roller shade material 122 is a generally flat panel of fabric or material that extends a vertical height from an upper end, which is attached to tube 116, and a lower end 186, and extends a lateral width between opposing sides 188. In the arrangement shown, as one example, roller shade material 122 is cut to the approximate width of tube 116 and ins installed such that the sides 188 of roller shade material 122 align with the ends 118 of tube 116.

In the arrangement shown, as one example, a bottom bar 124 is connected at or adjacent to the lower end 186 of roller shade material 122. Bottom bar 124 is formed of any suitable size, shape and design and is configured provide weight to the lower end 186 of roller shade material 122 so as to facilitate opening and closing of the roller shade material 122 while also maintaining the panel of fabric in a generally flat and straight manner. In one arrangement, bottom bar 124 is a plastic or metallic tube or rod that is connected to the lower end 186 of roller shade material 122 or is wrapped within a loop of roller shade material 122 at the lower end 186.

In one arrangement, roller shade assembly 114 may either be a manual shade, which opens or closes by manual operation, or a motorized shade, which opens or closes by operation of a motor. In one arrangement, wherein when roller shades assembly 114 is a manual shade, in one arrangement a pull cord or other manual operation mechanism is operatively connected to tube 116 that facilitates rotation of tube 116. In one arrangement a clutch mechanism is connected to tube 116 adjacent an end 118 and/or is positioned inside a hollow interior of the tube 116 that facilitates manual operation. In one arrangement, roller shade assembly 114 may be manually operated using a spring assist assembly that may be positioned within tube 116 that facilitates operation by pulling directly on the roller shade material 122.

In one arrangement, wherein when roller shade assembly 114 is a motorized shade, in one arrangement a motor, motor controller assembly, spring counterbalance assembly, and/or any other component necessary is positioned within the hollow interior of tube 116. When roller shade assembly 114 is motorized, the roller shade assembly 114 may be powered by an internal power source, such as one or more batteries positioned within the tube 116, or by an external power source such as one or more batteries positioned outside the tube 116, external line power, a solar cell, or any other form of or source of power external to the tube 116 that is electrically connected to the motor.

Regardless of whether roller shade assembly 114 is a manual shade or a motorized shade, the roller shade material 122 is opened or raised by rotating tube 116 in a first rotational direction. As tube 116 rotates upon its axis of rotation 184 that extends through the approximate center of tube 116 and axles 120, roller shade material 122 wraps around the cylindrical exterior surface of tube 116 and eventually around itself thereby raising the lower end 186 of roller shade material 122 and bottom bar 124.

Regardless of whether roller shade assembly 114 is a manual shade or a motorized shade, the roller shade material 122 is closed or lowered by rotating tube 116 in a second rotational direction, which is opposite the first rotational direction. As tube 116 rotates upon its axis of rotation 184 that extends through the approximate center of tube 116 and axles 120, roller shade material 122 to unwraps wraps from around the cylindrical exterior surface of tube 116 thereby lowering the lower end 186 of roller shade material 122 and bottom bar 124.

In this way, roller shade material 122 moves between a fully opened, or fully raised position wherein the lower end 186 and bottom bar 124 are positioned at, near, in, adjacent or as near as possible to the tube 116, brackets 126 and/or fascia 150; and a fully closed, or fully lowered position wherein the lower end 186 and bottom bar 124 are positioned away from or as far away from the tube 116, brackets 126 and/or fascia 150 as possible.

In this arrangement, as tube rotates 116 rotates, axles 120 are held by brackets 126 in a manner that constrains axles 120 while facilitating rotation of tube 116.

Any other configuration of roller shade assembly 114 is hereby contemplated for use. Alternatively, any other form of a window shade is hereby contemplated for use instead of and to replace roller shade assembly 114 in system 10, such as a roman shade, a venetian shade, a honeycomb shade, a vertical shade, a mini-blind, or any other form of a window shade. It is also worth noting that while only a single roller shade assembly 114 is shown in use with the system 10 (that is, one tube 116 and one roller shade material 122 is shown in use with a single fascia 150) any number of roller shade assemblies 114 are hereby contemplated for use with a single fascia 150. That is, two, three, four, five, six or more roller shade assemblies 114 may be used with a single fascia 150. In this way, multiple roller shade materials 122 may be independently raised and lowered independent of movement of opening or closing any drapery shade material 176 connected to the track 158 of fascia 150.

Brackets:

In the arrangement shown, as one example, roller shade and drapery window shade system 100 includes one or more brackets 126. Brackets 126 are formed of any suitable size, shape and design and are configured to hold axles 120 of roller shade assembly 114 while facilitating rotation of tube 116, as well as to facilitate attachment to a structure such as a wall or ceiling adjacent a window, as well as to facilitate attachment of fascia 150 to the system 10, among other features and functionalities.

In the arrangement shown, as one example, brackets 126 include an end wall 128. End wall 128 is formed of any suitable size, shape and design and is configured to be a central structural component of brackets 126 and facilitate strong and rigid connection to other components of bracket 126. In the arrangement shown, as one example, end wall 128 is a generally flat and planar member that when viewed from a side is generally square or rectangular in shape, however any other shape is hereby contemplated for use. In the arrangement shown, as one example, end wall 128 has an interior surface 190 and an opposing exterior surface 192.

In the arrangement shown, as one example, brackets 126 include a front wall 130. Front wall 130 is formed of any suitable size shape and design and is configured to facilitate connection of the front plate 154 of fascia 150 to bracket 126. In the arrangement shown, as one example, front wall 130 is a generally square or rectangular member that is connected to the front edge of end wall 128 and extends inward a distance therefrom in a generally flat and planar manner. In the arrangement shown, as one example, the plane of front wall 130 extends in a generally perpendicular manner to the plane formed by end wall 128. More specifically, in the arrangement shown, as one example, the outward edge 194 of front wall 130 connects to the forward edge of end wall 128, and the inward edge 196 of front wall 130 terminates in a free edge a distance inward from end wall 128. In the arrangement shown, as one example, the upper edge 198 of front wall 130 terminates in a free edge a short distance below the upper edge of end wall 128, and the lower edge 200 of front wall 130 terminates in a free edge a distance above the lower edge of end wall 128.

In the arrangement shown, as one example, brackets 126 include a rear wall 132. In the arrangement shown, as one example, rear wall 132 is similar if not identical to front wall 130, albeit connected to the rear edge of end wall 128 so as to facilitate reversible use of bracket 126. With that said, rear wall 132 is formed of any suitable size shape and design and is configured to facilitate connection of bracket 126 to a wall or other structural member in a rear mount application. In the arrangement shown, as one example, rear wall 132 is a generally square or rectangular member that is connected to the rear edge of end wall 128 and extends inward a distance therefrom in a generally flat and planar manner. In the arrangement shown, as one example, the plane of rear wall 132 extends in a generally perpendicular manner to the plane formed by end wall 128, and in a generally parallel manner to the plane formed by front wall 130. More specifically, in the arrangement shown, as one example, the outward edge 202 of rear wall 132 connects to the rearward edge of end wall 128, and the inward edge 204 of rear wall 132 terminates in a free edge a distance inward from end wall 128. In the arrangement shown, as one example, the upper edge 206 of rear wall 132 terminates in a free edge a short distance below the upper edge of end wall 128, and the lower edge 208 of rear wall 132 terminates in a free edge a distance above the lower edge of end wall 128.

In the arrangement shown, as one example, brackets 126 include a top wall 134. In the arrangement shown, as one example, top wall 134 is similar if not identical to front wall 130 and/or rear wall 132, albeit connected to the upper edge of end wall 128. With that said, top wall 134 is formed of any suitable size shape and design and is configured to facilitate connection of bracket 126 to a wall or ceiling or other structural member in a top mount application. In the arrangement shown, as one example, top wall 134 is a generally square or rectangular member that is connected to the upper edge of end wall 128 and extends inward a distance therefrom in a generally flat and planar manner. In the arrangement shown, as one example, the plane of top wall 134 extends in a generally perpendicular manner to the plane formed by end wall 128, as well as the planes of front wall 130 and rear wall 132. More specifically, in the arrangement shown, as one example, the outward edge 210 of top wall 134 connects to the upper edge of end wall 128, and the inward edge 212 of top wall 134 terminates in a free edge a distance inward from end wall 128. In the arrangement shown, as one example, the forward edge 214 of top wall 134 terminates in a free edge a short distance inward of the front edge of end wall 128, and the rearward edge 216 of top wall 134 terminates in a free edge a distance inward of the rear edge of end wall 128.

In the arrangement shown, as one example, brackets 126 include a bottom wall 136. In the arrangement shown, as one example, bottom wall 136 is formed of any suitable size shape and design and is configured to facilitate connection of the bottom plate 156 of fascia 150 to bracket 126. In the arrangement shown, as one example, bottom wall 136 is a generally square or rectangular member that is connected to the lower edge of end wall 128 and extends inward a distance therefrom in a generally flat and planar manner. In the arrangement shown, as one example, the plane of bottom wall 136 extends in a generally perpendicular manner to the plane formed by end wall 128, as well as the planes of front wall 130 and rear wall 132, and extends in a generally planar manner to the plane formed by top wall 134. More specifically, in the arrangement shown, as one example, the outward edge 218 of bottom wall 136 connects to the lower edge of end wall 128, and the inward edge 220 of bottom wall 136 terminates in a free edge a distance inward from end wall 128. In the arrangement shown, as one example, the forward edge 222 of bottom wall 136 terminates in a free edge a distance inward of the front edge of end wall 128, and the rearward edge 224 of bottom wall 136 terminates in a free edge a distance inward of the rear edge of end wall 128. In the arrangement shown, as one example, bottom wall 136 is a generally narrow member that is generally centrally positioned on the lower edge of end wall 128 so as to facilitate connection of fascia 150 thereto while also allowing roller shade assembly 114 to fit into brackets 126 from their bottom side.

In the arrangement shown, as one example, a lower receiver 226 is positioned on the forward side and rearward side of bottom wall 136. In the arrangement shown, as one example, lower receiver 226 is formed of a notch positioned at the intersection of the outward edge of 218 of bottom wall 136 and the forward edge 222 as well as the rearward edge 224 of bottom wall 136. In the arrangement shown, as one example, the notch of lower receiver 226 extends a distance upward into end wall 128 a distance from bottom wall 136. The lower receiver 226 on each side of bottom wall 136 is configured to receive a lower connection member 228 of similar size and shape positioned in the upper surface 230 of bottom plate 156 of fascia 150. In the arrangement shown, as one example, when viewed from the side lower receiver 226 is a generally square or rectangular shaped notch in end wall 128.

In the arrangement shown, as one example, an upper receiver 226 is positioned on inward side of the upper edge 198 of front wall 130 as well as on the inward side of the upper edge 206 of rear wall 132. In the arrangement shown, as one example, the forward upper receiver 232 is formed of a notch positioned at the intersection of the outward edge of 194 and upper edge 198 of front wall 130 and end wall 128. In the arrangement shown, as one example, the rearward upper receiver 232 is formed of a notch positioned at the intersection of the outward edge of 202 and upper edge 206 of rear wall 132 and end wall 128. In the arrangement shown, as one example, the notch of upper receiver 232 extends a distance downward into end wall 128 a distance from upper edge 198, 206. The upper receiver 232 on the inward side of front wall 130 and rear wall 132 is configured to receive an upper connection member 234 of similar size and shape connected to the upper edge 236 front plate 154 of fascia 150.

In the arrangement shown, as one example, end wall 128 of brackets 126 have a cut out section 238 positioned in the lower forward and lower rearward corners of end wall 128. In the arrangement shown, as one example, when viewed from the side, cut out sections 238 are generally square or rectangular with a generally flat and straight upper edge 240 that extends in a generally perpendicular manner to a generally flat and straight side edge 242. In the arrangement shown, as one example, upper edge 240 extends in a generally horizontal manner whereas side edge 242 extends in a generally vertical manner. In the arrangement shown, as one example, the lower end 200 of front wall 130 terminates at the upper edge 240 of the forward positioned cut out section 238, and the lower edge 208 of rear wall 132 terminates at the upper edge 240 of the rearward positioned cut out section 238. In the arrangement shown, as one example, the size and shape of cut out section 238 is configured to receive the interior peripheral shape of track 158 in fascia 150 as is further described herein.

In the arrangement shown, as one example, front wall 130, rear wall 132 and top wall 134 have a plurality of holes 244 therein. Holes 244 are formed of any suitable size, shape and design and are configured to facilitate the passage of fasteners through bracket 126 so as to facilitate installation of bracket 126 into a wall, ceiling or other structure. In the arrangement shown, as one example, front wall 130, rear wall 132 and top wall 134 each have three holes 244 therein, with the outward positioned holes 244 having a slot-shape to them that extends a length parallel to the length of the front wall 130, rear wall 132 or top wall 134 so as to facilitate a limited amount of fine adjustment, and a centrally positioned hole 244 that is generally circular in shape.

In the arrangement shown, brackets 126 are generally symmetric along a vertically extending line about the middle of end wall 128 equally spaced between front wall 130 and rear wall 132, and extending through the approximate middle of top wall 134 and bottom wall 136. In this way, brackets 126 are reversible in nature, meaning the same bracket 126 may be used on a left side or right side of a roller shade assembly 114.

In one arrangement, brackets 126 include an axle holder 138. Axle holder 138 is formed of any suitable size, shape and design and is configured to receive and hold axle 120 of roller shade assembly 120 therein. As stated herein, there are countless forms of roller shade assemblies 114 manufactured by countless entities, many of which have unique configurations of axles 120. System 10 is useful with all of these makes and models of roller shade assemblies 114. To facilitate this functionality, in one arrangement, brackets 126 are what are known as “universal” brackets meaning that they are compatible with all makes and models of roller shade assemblies 114. To facilitate this, in one arrangement, brackets 126 and/or more specifically end walls 128 are configured to receive removable axle holders 138 that are compatible with various makes and models of roller shade assemblies 114. In one arrangement, these axle holders 138 are attached to the end wall 128 of brackets 126 by screws, bolts or any other fastening member or method. In this way, a single bracket 126 may be used with all roller shade assemblies 114 by merely swapping out the axle holder 138. Once axle holder 138 is installed on the interior surface 190 of end wall 128, axle holder 138 receives and holds an axle 120 of roller shade assembly 114.

Center Bracket:

In the arrangement shown, as one example, roller shade and drapery window shade system 100 includes one or more center brackets 140. Center brackets 140 are formed of any suitable size, shape and design and are configured to hold and provide additional support for fascia 150 at positions between brackets 126, especially in applications where a longer fascia 150 is used with longer roller shade assemblies 114.

In the arrangement shown, as one example, center brackets 140 are formed of a generally flat and narrow member that includes a rear wall 142 that connects to a top wall 144 that connects to a front wall 146 that connects to a bottom wall 148. Center brackets 140 extend a width between opposing sides 246.

In the arrangement shown, as one example, center brackets 140 include a rear wall 142. Rear wall 132 is formed of any suitable size, shape and design and is configured to facilitate connection of center bracket 140 to a wall or other structural member in a rear mount application. In the arrangement shown, as one example, rear wall 142 is a generally square or rectangular member that has a free lower end 248 that connects at its upper end 250 to the rearward edge of top wall 144. In the arrangement shown, as one example, rear wall 142 extends between sides 246 and between lower end 248 and upper end 250 in a generally flat and planar manner. In the arrangement shown, as one example, the plane of rear wall 142 extends in a generally perpendicular manner to the plane formed by top wall 144 and bottom wall 148, and extends in a generally parallel manner to the plane formed by front wall 146. In the arrangement shown, as one example, rear wall 142 includes a plurality of holes 244 similar to if not identical to holes 244 in rear wall 132 of bracket 126.

In the arrangement shown, as one example, center brackets 140 include a top wall 144. Top wall 144 is formed of any suitable size shape and design and is configured to facilitate connection of center bracket 140 to a wall or other structural member in a top mount application. In the arrangement shown, as one example, top wall 144 is a generally square or rectangular member that connects at its rearward end to the upper end 250 of rear wall 142 and connects adjacent its forward end to the upper end 252 of front wall 146.

More specifically, in the arrangement shown, as one example, an upper receiver 254 is positioned between the forward end 256 of the top wall 144 and the upper end 252 of front wall 146. In the arrangement shown, as one example, the upper receiver 254 is formed of a notch positioned at the intersection of the forward end 256 of the top wall 144 and the upper end 252 of front wall 146. In the arrangement shown, as one example, when viewed from the side, upper receiver 254 forms a generally square or rectangular shaped notch or groove. In the arrangement shown, as one example, the peripheral shape of upper receiver 254 of center bracket 140 is similar to if not identical to the upper receiver 232 in brackets 126 in size, shape, design and placement. In this way, when brackets 126 and center brackets 140 are installed in alignment with one another the grooves of upper receiver 232 of brackets 126 and the grooves of upper receiver 254 of center brackets 140 are aligned such that fascia 150 may be installed across all brackets 126 and center brackets 140.

In the arrangement shown, as one example, top wall 144 extends between sides 246 and between its rearward end and forward end 256 in a generally flat and planar manner. In the arrangement shown, as one example, the plane of top wall 144 extends in a generally perpendicular manner to the plane formed by rear wall 142 and front wall 146, and extends in a generally parallel manner to the plane formed by bottom wall 148. In the arrangement shown, as one example, top wall 144 includes a plurality of holes 244 similar to if not identical to holes 244 in of bracket 126.

In the arrangement shown, as one example, center brackets 140 include a front wall 146. Front wall 146 is formed of any suitable size shape and design and is configured to facilitate connection of front plate 154 of fascia 150 to center bracket 140. In the arrangement shown, as one example, front wall 146 is a generally square or rectangular member that connects adjacent its upper end 252 to the forward end 256 of top wall 144 at upper receiver 254. The lower end 258 of front wall 146 connects to the forward end of bottom wall 148. In the arrangement shown, as one example, front wall 146 extends between sides 246 and between its upper end 252 and its lower end 258 in a generally flat and planar manner. In the arrangement shown, as one example, the plane of front wall 146 extends in a generally perpendicular manner to the plane formed by top wall 144 and bottom wall 148, and extends in a generally parallel manner to the plane formed by rear wall 142. In the arrangement shown, as one example, front wall 146 does not include any holes 244 like rear wall 142 and top wall 144, however it is hereby contemplated to include a plurality of holes 244 in front wall 146 as well. In the arrangement shown, the distance between the upper end 252 of front wall 146 and the lower end 258 of front wall 146 is approximately equal to the length of the interior surface of front plate 154 of fascia 150 between its upper edge and the top of the track 158, such that when fascia 150 is installed on center bracket 140 the forward facing surface of front wall 146 is in generally flat and flush alignment to the rearward facing surface of the front plate 154 of fascia 150, as is further described herein.

In the arrangement shown, as one example, center brackets 140 include a bottom wall 148. Bottom wall 148 is formed of any suitable size shape and design and is configured to facilitate connection of fascia 150 to center bracket 140 by serving as a stop surface and engagement point for fascia 150 upon installation. In the arrangement shown, as one example, bottom wall 148 is a generally square or rectangular member that connects adjacent its forward end to the lower end 258 of front wall 146. Bottom wall 148 extends rearward from its connection to the lower end 258 of front wall 146 and terminates in a free rearward end 260. In the arrangement shown, as one example, bottom wall 148 extends between sides 246 and between its forward end and rearward end 260 in a generally flat and planar manner. In the arrangement shown, as one example, the plane of bottom wall 148 extends in a generally perpendicular manner to the plane formed by rear wall 142 and front wall 146, and extends in a generally parallel manner to the plane formed by top wall 144. In the arrangement shown, as one example, bottom wall 148 does not include any holes 244 like rear wall 142 and top wall 144 due to its substantially shorter length between its forward end and rearward end 260, however it is hereby contemplated to include a one or a plurality of holes 244 in bottom wall 148 as well. In the arrangement shown, the length between its forward end and rearward end 260 of bottom wall 148 is short so as to not have bottom wall 148 protrude substantially into the hollow interior 262 formed within the center of center bracket 140 as this could interfere with the bottom-up installation of roller shade assembly 114. In the arrangement shown, as one example, when fascia 150 is installed on center bracket 140, the bottom surface of bottom wall is in generally flat and flush alignment to upper interior surface of the track of fascia 150, as is further described herein.

In the arrangement shown, as one example, center bracket 140 is formed of a single, continuous, solid and monolithic member that must then be installed as a single member. In some arrangements, installing center bracket 140 as a single solid member poses problems as the roller shade assembly 114 needs to be installed after the center bracket 140 is installed. That is, the rearward extension of bottom wall 148 of center bracket 140 can interfere with and/or prevent the upward installation of roller shade assembly 114 into the hollow interior of center bracket 140.

As such, in an alternative arrangement, to alleviate this problem, center bracket 140 is formed of multiple parts that join together to form center bracket 140 that perform the functionality of center bracket 140 as is described herein. In one arrangement, center bracket 140 is formed of a rear section that includes rear wall 142 and at least a portion of a top wall 144, and a front section that includes at least a portion of a top wall 144 as well as front wall 146 and bottom wall 148. In one arrangement, center bracket 140 is formed of a rear section that includes rear wall 142, top wall 144, and at least a portion of front wall 146, and a front section that includes at least a portion of a front wall 146 as well as bottom wall 148. In this arrangement, the rear section and front section of this multi-part center bracket 140 connect to one another in a manner that allows the rear section to be installed into the wall or structure, then the roller shade assembly 114 is installed, then the front section of the center bracket 140 is installed onto and/or moved into place on the rear section. In this arrangement, the rear section and front section of center bracket 140 may be locked onto one another and fixed in place by a locking arrangement such as a spring loaded member, a set screw, a bolt, or any other locking or affixing arrangement. In one arrangement, the front section and rear section of the multi-part center bracket 140 connect to one another in a sliding rail and groove arrangement wherein one of the rear section and front section slides over the other of the rear section and front section.

In another arrangement, multi-part center bracket 140 is formed of any number of parts, such as three, four, or more parts that connect together to form the whole of center bracket 140. In another arrangement, center bracket 140 may include one or more hinges that facilitate movement of portions of center bracket 140 out of the way while roller shade assembly 114 is installed. In this arrangement, center bracket 140 may be locked in a closed position by way of a spring loaded member, a set screw, a bolt, or any other locking or affixing arrangement after the roller shade assembly 114 is installed.

Any other arrangement or configuration of center bracket 140 is hereby contemplated for use.

Fascia & Track:

In the arrangement shown, as one example, roller shade and drapery window shade system 100 includes a fascia 150. Fascia 150 is formed of any suitable size, shape and design is configured to enclose the roller shade assembly 114 and in doing so provide an improved aesthetic appearance to the system 10, fascia 150 also serves to provide for an attachment point for drapery shade material 176 in track 158.

In the arrangement shown, as one example, fascia 150 is formed of a single extruded member that extends a length between opposing ends 152 in a monolithic and solid and consistent manner from end 152 to end 152. In the arrangement shown, as one example, fascia 150 has a front plate 154 and a bottom plate 156. In the arrangement shown, as one example, front plate 154 and bottom plate 156 are generally flat and straight members with the plane formed by the front plate 154 extending at approximately a perpendicular manner to the plane formed by bottom plate 156.

Front plate 154 extends a length from upper edge 236 to lower edge 264 and has a generally flat and straight front surface 266 that extends in approximate parallel alignment to a generally flat and straight rear surface 268. Upper connection member 234 is connected to the upper edge 236 of front plate 154. In the arrangement shown, as one example, when viewed from the side, upper connection member 234 is a generally hook shaped member that extends rearward and downward at an angle. Upper connection member 234 is configured to be hooked onto, or engaged with, upper receiver 232 of brackets 126 as well as upper receiver 254 of center brackets 140. That is, as is shown in the figures, upper connection member 234 is configured to reach over and around the upper edge 198 of front wall 130 of brackets 126 with the lower end of upper connection member 234 being received within the groove formed by the upper receiver 232; similarly, upper connection member 234 is configured to reach over and around the upper edge 252 of front wall 146 of center brackets 140 with the lower end of upper connection member 234 being received within the groove formed by the upper receiver 254. In this way, upper connection member 234 secures the upper end of fascia 150 to brackets 126 and center brackets 140 in a quick, easy and secure manner.

Bottom plate 156 extends a length from the lower edge 264 of front plate 154 rearward to the rearward end 260 and has a generally flat and straight upper surface 230 that extends in approximate parallel alignment to a generally flat and straight lower surface 270. Lower connection member 228 is connected to the upper surface 230 of bottom plate 156 a distance inward from rearward end 260 of bottom plate. In the arrangement shown, as one example, when viewed from the side, lower connection member 228 is a generally square or rectangular shaped member that extends upward a distance from the upper surface 230 of bottom plate 156 in a generally square and perpendicular manner to the plane formed by bottom plate 156. Lower connection member 228 is configured to be received within, snapped into, or engaged with, lower receiver 226 of brackets 126. That is, as is shown in the figures, lower connection member 228 is configured to naturally fit upward and into the downward facing groove of lower receiver 226 with close and tight tolerances. In this way, lower connection member 228 secures the rearward end 260 of bottom plate 156 of fascia 150 to brackets 126 in a quick, easy and secure manner.

In the arrangement shown, as one example, track 158 is positioned at the intersection of front plate 154 and bottom plate 156. In the arrangement shown, when viewed from the side, track 158 includes a top wall 160 that connects to and extends rearward from the rear surface 268 of front plate 154. The rearward end of top wall 160 connects to the upper end of rear wall 162 of track 158. Rear wall 162 of track 158 extends downward from its connection to the rearward end of top wall 160 until it engages the upper surface 230 of bottom plate 156. In the arrangement shown, as one example, the planes formed by top wall 160 and rear wall 162 extend in a generally perpendicular alignment to one another, and the plane formed by top wall 160 extends in a generally perpendicular manner to the plane of front plate 154 and in generally parallel manner to the plane formed by bottom plate 156, and the plane formed by rear wall 162 extends in a generally perpendicular manner to the plane formed by bottom plate 156 and in a generally parallel manner to the plane formed by front plate 154. In this way, with the combination of the front plate 154 and bottom plate 156 of fascia 150 and the top wall 160 and rear wall 162 of track 158 a generally square or rectangular hollow interior 164 is formed. In the arrangement shown, as one example, a slot 166 is generally centrally positioned with the hollow interior 164 of track 158. Any other shape or form of tracks 158 is hereby contemplated for use. In addition, while only a single track 158 is shown in fascia 150 any number of tracks 158 are hereby contemplated for use in fascia 150 such as two, three, four, five, six or more.

Carriers and Drapery Shad Material:

In the arrangement shown, as one example, roller shade and drapery window shade system 100 includes a plurality of carriers 168. Carriers 168 are formed of any suitable size, shape and design are configured to connect drapery shade material 176 to track 158 and facilitate sliding opening and closing motion of the drapery shade material 176 within track 158.

In the arrangement shown, as one example, carriers 168 include a roller assembly 170 that is configured to roll within the hollow interior 164 of track 158. Roller assembly 170 is formed of any suitable size, shape and design. In the arrangement shown, as one example, roller assembly 170 includes a pair of wheels spaced apart from one another by an axle 272 that extends between and connects to the wheels. Roller assembly 170 is configured to fit within the hollow interior 164 of track 158 and rolls along a length of track 158 to facilitate opening and closing of the drapery shade material. In the arrangement shown, as one example, the wheels of roller assemblies roll on the upper surface of the bottom plate 156 adjacent each side of slot 166. In the arrangement shown, as one example, the exterior sides of wheels of roller assemblies 170 are in flat and flush alignment to the interior surface of front plate 154 on one side and the interior surface of rear wall 162 on the opposite side. In this way, the close tolerances between roller assemblies 170 and the sides of track 158 maintain alignment of roller assemblies 170 within track 158. In the arrangement shown, as one example, carriers 168 include an arm 172 that is configured to connect to roller assembly 170 to connector 174. Arm 172 is formed of any suitable size, shape and design. In the arrangement shown, as one example, arm 172 is an elongated member that connects at its upper end to approximate middle of roller assembly 170 at or around axle 272 and extends downward therefrom and connects at or around the lower end of arm 172 to connector 174. In this way, arm 172 connects roller assembly 170 to connector 174. Arm 172 also helps to maintain alignment of carrier 168 as arm 172 extends through slot 166 thereby preventing rotation or misalignment of carrier 168 with respect to track 158 as carrier 168 slides along track 158. In the arrangement shown, as one example, carriers 168 include a connector 174 that is configured to connect carrier 168 to drapery shade material 176. Connector 174 is formed of any suitable size, shape and design. In the arrangement shown, as one example, connector 174 is formed of hook member that connects at its upper end to the lower end of arm 172 and connects at its lower end to drapery shade material 176.

In the arrangement shown, as one example, roller shade and drapery window shade system 100 includes at least one drapery shade material 176. Drapery shade material 176 is formed of any suitable size, shape and design and is configured to be opened and closed, sliding movement along the length of fascia 150 while providing an aesthetically pleasing visual appearance while allowing a desirable amount of light into the building. In the arrangement shown, as one example, drapery shade material 176 is a panel of fabric or material that extends a lateral width between opposing sides 178 and extends a vertical height between an upper end 180 and a lower end 182. In the arrangement shown, as one example, the upper end 180 of drapery shade material 176 is connected to connectors 174 of carriers 168 which are spaced a distance along the length of drapery shade material 176.

Drapery shade material 176 may be what is known as a ripple fold drapery, a pinch pleat drapery, a tailored pleat drapery, an inverted pleat drapery, a goblet drapery, a grommet drapery, a pocket drapery, a cubicle drapery or any other form of a drapery.

A single drapery shade material 176 may be attached to fascia 150 and in this arrangement system 10 is a side opening and closing drapery. In this arrangement, drapery shade material 176 opens and closes by sliding one side of 178 of drapery shade material 176 toward or away from an end 152 of fascia 150. In this way, in a closed state, carriers 168 are spaced away from one another along the length of fascia 150 as the drapery shade material 176 covers the length of fascia 150 with drapery shade material 176 in an expanded configuration, and in an open state, carriers 168 are compressed against one another toward one end 152 of fascia 150 as the drapery shade material 176 covers only a small portion of the length of fascia 150.

A pair of drapery shade material 176 may be attached to fascia 150 and in this arrangement system 10 is a center opening or center closing drapery. In this arrangement the opposing drapery shade material 176 open and close by sliding one side of 178 of drapery shade material 176 toward or away from one another and toward or away from an end 152 of fascia 150. In this way, in a closed state, carriers 168 are spaced away from one another along the length of fascia 150 as the drapery shade materials 176 cover the length of fascia 150 with drapery shade materials 176 in an expanded configuration, and in an open state, carriers 168 are compressed against one another toward one end or the center 152 of fascia 150 as the drapery shade materials 176 covers only a small portion of the length of fascia 150.

Installation of Brackets and Center Brackets:

In the arrangement shown, as one example, brackets 126 are installed in a wall or ceiling or other structural member by passing fasteners through holes 144 in either the end wall 128, rear wall 132 and/or top wall 134. Installed brackets 126 are configured to be placed at the desired distance away from each other that suits the length of the corresponding roller shade assembly 114. Any number of brackets 126 and roller shade assemblies 114 may be installed for use with a single fascia 150. When there are long expansions of fascia 150 and/or for additional strength and rigidity, center brackets 140 are installed between opposing brackets 126 at desired positions. Center brackets 140 may be installed by passing fasteners through holes 244 in the rear wall 142 and/or the top wall 144. Center brackets 140 may be installed before or after fascia 150 is attached to brackets 126.

Installation of Roller Shade Assemblies:

In the arrangement shown, as one example, once brackets 126 are installed, roller shade assemblies 114 are installed between opposing brackets 126. In the arrangement shown, as one example, this is accomplished by inserting axles 120 positioned at each end of tube 116 into the axle holder 138 in the end wall 128 of brackets 126. In this way, brackets 126 hold axles 120 while supporting and allowing for rotation of tube 116 to open and close the roller shade material 122 connected to tube 116. This installation is repeated for each roller shade assembly 114.

Installation of Fascia on Brackets and Center Brackets:

In the arrangement shown, as one example, upper connection member 234 of fascia 150 is easily installed into the grooves formed by upper receiver 232 of brackets 126 and the upper receiver 254 of center brackets 140. To facilitate this installation, the fascia 150 is raised up to brackets 126 and center brackets 140, which are already installed in the wall or ceiling of a structure. The rear surface 268 of front plate 152 is angled slightly toward brackets 126 and center brackets 140 as the upper edge 236 of front plate 154, or interior edge of upper connection member 234 is slid upward along the front surface of front wall 130 of brackets 126 and the front wall 146 of center brackets 140. Once the lower end of upper connection member 234 passes the upper edge 198 of brackets 126 and the upper edge 252 of center brackets 140, fascia 150 is pushed rearward toward brackets 126 and center brackets 140 thereby causing upper connection member 234 to be received within the groove of upper receiver 232 of brackets 126 and the upper receiver 254 of center brackets 140 thereby securing the upper end 236 of fascia 150 to brackets 126 and center brackets 140.

Once the upper end 236 of front plate 154 of fascia 150 is secured to brackets 126 and center brackets 140, next the bottom plate 156 is secured to brackets 126 and center brackets 140. This is accomplished in the following manner. With the upper connection member 234 received within the groove of upper receiver 232 of brackets 126 and the upper receiver 254 of center brackets 140, the bottom plate 156 is rotated toward brackets 126 and center brackets 140. In doing so, the upper edge of lower connection member 228 slides over and past the bottom surface of bottom wall 136 of brackets 126 until the lower connection member 228 of bottom plate 156 slides past the rearward edge 224 at which point the lower connection member 228 naturally snaps into the groove of lower receiver 226 under the bias of fascia 150.

That is, fascia 150 and brackets 126 are sized and shaped to fit snugly and frictionally with one another in a tight and locking arrangement. When fascia 150 is installed on brackets 126 the upper connection member 234 is snugly received within the groove of upper receiver 232 of brackets 126, the rear face 268 of front plate 154 of fascia 150 is in flat and flush engagement with the forward face of front wall 130 of brackets 126, the track 158 is received within cutout section 238 in the forward side of brackets 126 with the upper surface of top wall 160 of track 158 engaged with the upper edge 240 of cut out section 238 and the rear wall 162 of track 158 engaged with the side edge 242 of cut out section 238, and the upper surface 230 of bottom plate 156 is in flat and flush engagement with the lower surface of bottom wall 136 of brackets 126. In this position, there is a tension, or spring bias, forcing the lower connection member 228 into the groove of lower receiver 226. Or, said another way, the front plate 154 and bottom plate 156 of fascia 150 are sized and shaped to have to elastically stretch or bend in order to facilitate installation onto brackets 126. As such, when fascia 150 is installed onto brackets 126, fascia 150 securely attaches and holds onto brackets 126. This prevents rattling and relative motion between brackets 126 and fascia 150 and provides a secure and strong connection. To install fascia 150 onto brackets 126 force must be applied when bottom plate 156 is rotated onto brackets 126 that overcomes the spring bias of the fascia. In this way, fascia 150 is quickly and easily installed on brackets 126 in a secure manner without the use of any tools.

In the arrangement shown, as one example, when fascia 150 is installed on to brackets 150, the lower end of upper connection member 234 engages the upper surface of the groove of upper receiver 232 of brackets 126 under tension and/or the lower surface of upper connection member 234 engages the upper surface of upper edge 198 of front wall 130 of brackets 126 under tension. Similarly, in the arrangement shown, as one example, when fascia 150 is installed on to brackets 150, the upper end of lower connection member 228 engages the upper surface of the groove of lower receiver 226 of brackets 126 under tension and/or the forward facing surface of lower connection member 228 engages the rearward edge 224 of bottom wall 136 of brackets 126 under tension. In this way, and with the engagement of these components, fascia 150 is securely held in place on brackets 126 thereby preventing fascia 150 from unintentionally coming off of brackets 126, even under extreme conditions.

Similarly, to remove fascia 150 from brackets 126, force is applied to the rearward end 260 of bottom plate 156 pulling the bottom plate 156 downward. As bottom plate 156 is pulled downward, the natural spring bias of fascia 150 is overcome thereby pulling lower connection member 228 of bottom plate 156 out of the groove of lower receiver 226 of brackets 126. Once lower connection member 228 of bottom plate 156 is free from lower receiver 226, the bottom plate 156 of fascia 150 is rotated away from brackets 126 while upper connection member 234 remains in upper receiver 232 of brackets 126. In doing so, bottom plate 156 clears brackets. Once bottom plate 156 clears brackets 126, fascia 150 may be raised slightly thereby removing upper connection member 234 from upper receiver 232 of brackets 126 and the fascia 150 may be fully removed from engagement with brackets 126. In this way, fascia 150 is quickly and easily removed from its strong and secure connection to brackets 126 by hand without the use of tools.

Fascia 150 is similarly installed onto and removed from center brackets 140 in a similar if not identical manner. In the arrangement shown, as one example, one difference is that when fascia 150 is installed upon center brackets 140 the bottom surface of bottom wall 148 of center brackets 140 engages the upper surface of top wall 160 of track 158. In this way, the engagement between bottom wall 148 of center brackets 140 with the upper surface of top wall 160 of track 158 serves as a stop surface. That is, the engagement between bottom wall 148 of center brackets 140 with the upper surface of top wall 160 of track 158 causes a tension between upper connection member 234 and track 158 helping to securely hold fascia 150 onto center brackets 140, much in the same way that spring bias of fascia 150 forces lower connection member 228 into the groove of lower receiver 226.

Installation of Drapery Shade Material:

Drapery shade material 176 may be installed on fascia 150 either before or after installation of fascia on brackets 126 and/or center brackets 140. In the arrangement shown, as one example, a plurality of carriers 168 are installed into the hollow interior 164 of track 158 by aligning the roller assembly 170 of carriers 168 with an open end 152 of track 158 and inserting the roller assembly 170 within the hollow interior 164 while the lower end of arm 172 protrudes through slot 166 in the lower end of track 158. Once the desired number of carriers 168 are installed to match the length of the track 158, in one arrangement the ends 152 of track 158 is closed or stopped by the insertion of a cover or other stop member that prevents the carriers 168 from rolling out the end 152 of track 158. In one arrangement, wherein when two drapery shade materials 176 are used a stop member may be inserted at the center of track 158, or at any portion along track 158 to stop one drapery shade material 176 from engaging the other drapery shade material 176.

Carriers 168 may be connected to drapery shade material 176 before or after carriers 168 are installed into track 158. In the arrangement shown, as one example, carriers 168 are connected to drapery shade material 176 by inserting the lower end of connector 174, which in the arrangement shown is a hook, through the material itself or through a hole or grommet in the drapery shade material 176 at or near its upper end 180.

Strength of System:

One benefit of the system 10 is that it is configured to be extremely strong and prevents unintentional separation of fascia 150 from brackets 126 even under the most extreme conditions, such as a child pulling downward on the drapery shade material 176. This is because there is no moment, or practically no moment on the fascia 150 when the drapery shade material 176 is pulled on. This is because the upper connection member 234 of fascia 150 is hooked onto and over the upper edge 198 of front wall 130 of brackets 126 and the interior surface 268 of front plate 154 extends in flat and flush alignment to the forward surface of front wall 130 of brackets 126. This is while the lower connection member 228 of bottom plate 156 is securely held in the lower receiver 226 of brackets 126, thereby holding fascia 150 in a manner that prevents rotation of fascia 150 upon brackets 126. There is no way, or practically no way to make the lower connection member 228 of bottom plate 156 come out of the lower receiver 226 of brackets 126 by pulling on or otherwise interacting with drapery shade material 176 which is attached to track 158. This is because pulling down on the drapery shade material 176 causes an increase in strength in the connection between upper connection member 234 and upper receiver 232, and pulling forward on the drapery shade material 176 causes an increase in strength in the connection between the forward facing surface of lower connection member 228 and the rearward edge 224 of bottom wall 136. As such, pulling downward and/or forward on the drapery shade material 176 acts to strengthen the connection between brackets 126 and fascia 150. The strength of this connection is further aided by the long rearward extension of bottom plate 156. Again, to remove lower connection member 228 from lower receiver 226 due to the natural bias of fascia 150 a downward force must be applied at or near the rearward end 260 of bottom plate 156 which is impossible or practically impossible to accomplish by pulling on drapery shade material 176. As such, fascia 150 of the system 10 presented cannot unintentionally be dislodged from brackets 126 which increases the safety of the system 10. That is, a great benefit in strength and safety is provided by positioning the upper connection member 234 a great and/or maximum distance above the track 158, and a great benefit in strength and safety is provided by simultaneously positioning the lower connection member 228 a great and/or maximum distance rearward of track 158.

In practice, even the strongest drapery shade materials 176 will tear, or alternatively carriers 168 will fail, before effecting the engagement between fascia 150 and brackets 126. The security of this attachment is enhanced by the addition of one or more center brackets 140.

In Operation:

Once roller shade and drapery window shade system 10, 100 is assembled the system 10, 100 facilitates endless ways of limiting light into a room and setting an aesthetically pleasing appearance by raising or lowering the roller shade material 122 of roller shade assemblies 114 by rotating tube 116, and by laterally opening and closing drapery shade materials 176 by sliding carriers 168 along a length of track 158.

By providing both roller shade materials 122 as well as drapery shade materials 176 in a single, compact, easy to install, strong, safe, convenient, easy to operate and aesthetically pleasing configuration, the a better window shade is presented as users may select the optimum material for roller shade material 122 and the optimum material for drapery shade material 176. That is, because the user gets to select two shade materials for use in a single window shade system 10, 100 the user may select an opaque material and a sheer material meaning the user does not have to sacrifice. Then, the user may adjust these two shade materials to the optimum positions depending on the conditions at the time. In this way, the system 10, 100 presented herein provides a substantially improved window shade system 10.

One of the benefits of the system 10, 100 presented herein is that the track 158 occupies “dead space” in the brackets 126. That is, with roller shade assembly 114 inherently having a circular cross-sectional shape, and with the brackets 126 having a generally square or rectangular shape, track 158 occupies the “dead space” at the forward lower corner of the brackets 126. In this way, the addition of track 158 does not interfere with operation of the roller shade assembly 114. In this way, the addition of track 158 does not make the system 10, 100 dimensionally larger. In this way, the addition of track 158 does not require additional parts or pieces. In this way, the addition of track 158 does not require additional assembly. In this way, the addition of track 158 is a seamless addition that does not increase complexity of the system, does not substantially increase cost, and does not substantially affect the overall appearance of the system 10. 100. In fact, there is no need or requirement to install drapery shade material 176 to track 158. In fact, when no drapery shade material 176 is installed, the presence of track 158 is practically unnoticeable as all that is visible is the narrow and unnoticeable slot 166 in the bottom plate 156.

From the above discussion it will be appreciated that the roller shade and drapery window shade system 10, 100 and related method of use, presented herein improves upon the state of the art.

Specifically, the roller shade and drapery window shade system presented: provides improved functionality over prior art systems; provides improved features over prior art systems; improves upon the prior art; provides the benefits of a roller shade; provide a window shade system that does not suffer from the disadvantages of a roller shade; provides the benefits of a drapery; provide a window shade system that does not suffer from the disadvantages of a drapery; combines the benefits of a roller shade and a drapery; that eliminates the deficiencies of roller shades and draperies; that is easy to install; that is easy to use; that that is simple to install; that is simple to use; that is relatively inexpensive; that can be used with practically any roller shade; that can be used with practically any brackets; that can be used with practically any window; that is aesthetically pleasing; that provides improved functionality; that facilitates the selection of optimum shade material for use with the window shade system; that has a small and unobtrusive stature when installed; that has a sleek appearance; that is safe to use; that allows for use of a drapery with a roller shade but does not require use of a drapery with a roller shade; that allows for use of a roller shade with a drapery but does not require use of a roller shade with a drapery; that can be used to modify existing roller shades to include add a drapery; that efficiently allows for the use of a sheer material as well as an opaque material in a single window shade system; that is intuitive to use; that strong and robust; that can be used in many applications; that provides unique functionality; that saves time; that is pleasing to use; that has a compact size; that can be used in any length; that can be used in any height; that has a long useful life; that is high quality; that can be used with practically any shade material; that eliminates the need to install two separate window shades, among countless other advantages and improvements.

It will be appreciated by those skilled in the art that other various modifications could be made to the device without parting from the spirit and scope of this disclosure. All such modifications and changes fall within the scope of the claims and are intended to be covered thereby.

What is claimed:

1. A window shade system, comprising:
a first roller shade assembly;
the first roller shade assembly comprising:
a tube;
the tube extending a length between a first end and a second end;
the tube having a generally cylindrical cross sectional shape;
a first axle operatively connected to the first end of the tube;
a second axle operatively connected to the second end of the tube;
a first bracket;
a second bracket;
wherein the first axle is operatively connected to the first bracket;
wherein the second axle is operatively connected to the second bracket;
roller shade material operatively connected to the tube;
a fascia;
the fascia extending a length between a first end and a second end;
the fascia having a front plate and a bottom plate;
a track;
the track having a hollow interior positioned in the fascia and extending a length of the fascia from the first end to the second end;
a slot positioned in a lower side of the track;
a first plurality of carriers;
the first plurality of carriers positioned in the track of the fascia;
a first drapery shade material operatively connected to the first plurality of carriers;
wherein the fascia is operatively to the first bracket;
wherein the fascia is operatively to the second bracket;
wherein when the tube of the first roller shade assembly is rotated in a first rotational direction the roller shade material of the first roller shade assembly wraps around the tube thereby opening the roller shade material;
wherein when the tube of the first roller shade assembly is rotated in a second rotational direction, which is opposite the first rotational direction, the roller shade material of the first roller shade assembly unwraps around the tube thereby closing the roller shade material;
wherein the first drapery shade material is closed by sliding the plurality of couplers in the track in a first lateral direction along a length of the fascia;
wherein the first drapery shade material is opened by sliding the plurality of couplers in the track in a second lateral direction, opposite the first lateral direction, along a length of the fascia.

2. The system of claim 1, wherein the track extends the entire length of the fascia from the first end to the second end in a continuous and uninterrupted manner.

3. The system of claim 1, wherein when viewed from the side, the track has a generally square or rectangular shape with the slot positioned approximately in the middle of the lower side of the track.

4. The system of claim 1, wherein the first plurality of carriers include:
a roller assembly;
an arm; and
a connector;
wherein the roller assembly of the plurality of carriers are positioned within the track of the fascia;
wherein the arm of the plurality of carriers extend through the slot positioned in the lower side of the track of the fascia;
wherein the connector of the plurality of carriers operatively connects to the drapery shade material.

5. The system of claim 1, wherein the fascia is operatively connected at its first end to the first bracket.

6. The system of claim 1, wherein the fascia is operatively connected at its second end to the second bracket.

7. The system of claim 1, further comprising a second drapery shade material operatively connected a second plurality of carriers positioned in the track.

8. The system of claim 1, wherein the front plate and the bottom plate are approximately perpendicularly aligned to one another.

9. The system of claim 1, wherein the front plate has a generally flat front surface and the bottom plate has a generally flat bottom surface.

10. The system of claim 1, wherein the front plate and bottom plate are joined together at the track which is positioned at the intersection of the front plate and the bottom plate.

11. The system of claim 1, wherein the track is positioned at a lower end of the front plate and at a forward end of the bottom plate.

12. The system of claim 1, further comprising a second roller shade assembly operatively connected to the fascia.

13. The system of claim 1, further comprising:
a second roller shade assembly operatively connected to the fascia;
the second roller shade assembly comprising:
a tube;
the tube extending a length between a first end and a second end;
the tube having a generally cylindrical cross sectional shape;
a first axle operatively connected to the first end of the tube;
a second axle operatively connected to the second end of the tube;
a first bracket;
a second bracket;
wherein the first axle is operatively connected to the first bracket;
wherein the second axle is operatively connected to the second bracket;
roller shade material operatively connected to the tube.

14. The system of claim 1, further comprising a first connection member positioned adjacent a forward upper end of the fascia, wherein the fascia connects to the first bracket and the second bracket at the first connection member.

15. The system of claim 1, further comprising a second connection member positioned adjacent a rearward lower end of the fascia, wherein fascia connects to the first bracket and the second bracket at the second connection member.

16. The system of claim 1, wherein the first bracket has a cut out section positioned in a forward lower corner of the first bracket, wherein second bracket has a cut out section positioned in a forward lower corner of the second bracket, wherein the track of the fascia is positioned in the cut out section of the first bracket and the cut out section of the second bracket.

17. A window shade system, comprising:
a first roller shade assembly;
the first roller shade assembly comprising:
a tube;
the tube extending a length between a first end and a second end;
the tube having a generally cylindrical cross sectional shape;
a first axle operatively connected to the first end of the tube;
a second axle operatively connected to the second end of the tube;
a first bracket;
a second bracket;
wherein the first axle is operatively connected to the first bracket;
wherein the second axle is operatively connected to the second bracket;
roller shade material operatively connected to the tube;
a fascia;
the fascia extending a length between a first end and a second end;
a track;
the track having a hollow interior positioned in the fascia and extending a length of the fascia from the first end to the second end;
a slot positioned in a lower side of the track;
a first plurality of carriers;
the first plurality of carriers positioned in the track of the fascia;
a first drapery shade material operatively connected to the first plurality of carriers;
wherein the fascia is operatively to the first bracket;
wherein the fascia is operatively to the second bracket;
wherein when the tube of the first roller shade assembly is rotated in a first rotational direction the roller shade material of the first roller shade assembly wraps around the tube thereby opening the roller shade material;
wherein when the tube of the first roller shade assembly is rotated in a second rotational direction, which is opposite the first rotational direction, the roller shade material of the first roller shade assembly unwraps around the tube thereby closing the roller shade material;
wherein the first drapery shade material is closed by sliding the plurality of couplers in the track in a first lateral direction along a length of the fascia;
wherein the first drapery shade material is opened by sliding the plurality of couplers in the track in a second lateral direction, opposite the first lateral direction, along a length of the fascia.

18. The system of claim 17, wherein the fascia has a front plate and a bottom plate.

19. The system of claim 17, wherein the fascia has a front plate and a bottom plate, wherein the front plate and the bottom plate are approximately perpendicularly aligned to one another.

20. The system of claim 17, wherein the fascia has a front plate and a bottom plate, wherein the front plate has a generally flat front surface and the bottom plate has a generally flat bottom surface.

21. Wherein the fascia has a front plate and a bottom plate joined together at an intersection, wherein the track is positioned at the intersection of the front plate and the bottom plate.

22. Wherein the fascia has a front plate and a bottom plate, wherein the track is positioned at a lower end of the front plate and at a forward end of the bottom plate.

23. A window shade system, comprising:
a first roller shade assembly;
the first roller shade assembly having a tube and roller shade material operatively connected to the tube;
a first bracket;
a second bracket;
wherein the tube operatively connects to the first bracket and the second bracket;
a fascia;
the fascia having a front plate and a bottom plate;
a track;
the track positioned in the fascia adjacent a forward lower section of the fascia;
wherein the fascia operatively connects to the first bracket and the second bracket;
a first drapery shade material operatively connected to the track;
wherein the roller shade material of the first roller shade assembly is opened by rotating the tube in a first rotational direction and is closed by rotating the tube in a second rotational direction, opposite the first rotational direction;
wherein the first drapery shade material is opened by sliding the first drapery shade material in a first lateral direction along the track and is closed by sliding first drapery shade material in a second lateral direction along the track, opposite to the first lateral direction.

24. The system of claim 23, wherein the track extends the entire length of the fascia from a first end to a second end in a continuous and uninterrupted manner.

25. The system of claim 23, wherein when viewed from the side, the track has a generally square or rectangular shape with a slot positioned approximately in the middle of a lower side of the track.

26. The system of claim 23, wherein the first drapery shade material is operably connected to a first plurality of carriers positioned in the track.

27. The system of claim 23, wherein the fascia is operatively connected at its first end to the first bracket.

28. The system of claim 23, wherein the fascia is operatively connected at its second end to the second bracket.

29. The system of claim 23, further comprising a second drapery shade material operatively connected a second plurality of carriers positioned in the track.

30. The system of claim 23, wherein the fascia has a front plate and a bottom plate, wherein the front plate and the bottom plate are approximately perpendicularly aligned to one another.

31. The system of claim 23, wherein the fascia has a front plate and a bottom plate, wherein the front plate has a generally flat front surface and the bottom plate has a generally flat bottom surface.

32. The system of claim 23, herein the fascia has a front plate and a bottom plate joined together at an intersection, wherein the track is positioned at the intersection of the front plate and the bottom plate.

33. The system of claim 23, herein the fascia has a front plate and a bottom plate, wherein the track is positioned at a lower end of the front plate and at a forward end of the bottom plate.

34. The system of claim 23, further comprising a second roller shade assembly operatively connected to the fascia.

35. The system of claim 23, further comprising a first connection member positioned adjacent a forward upper end of the fascia, wherein the fascia connects to the first bracket and the second bracket at the first connection member.

36. The system of claim 23, further comprising a second connection member positioned adjacent a rearward lower end of the fascia, wherein fascia connects to the first bracket and the second bracket at the second connection member.

37. The system of claim 23, wherein the first bracket has a cut out section positioned in a forward lower corner of the first bracket, wherein second bracket has a cut out section positioned in a forward lower corner of the second bracket, wherein the track of the fascia is positioned in the cut out section of the first bracket and the cut out section of the second bracket.

38. A window shade system, comprising:
a first roller shade assembly;
the first roller shade assembly having a tube and roller shade material operatively connected to the tube;
a first bracket;
a second bracket;
wherein the tube operatively connects to the first bracket and the second bracket;
a fascia;
wherein the fascia operatively connects to the first bracket and the second bracket;
a track;
the track positioned in the fascia;
a first drapery shade material operatively connected to the track;
wherein the roller shade material of the first roller shade is opened by rotating the tube in a first rotational direction and is closed by rotating the tube in a second rotational direction, opposite the first rotational direction;
wherein the first drapery shade material is opened by sliding the first drapery shade material in a first lateral direction along the track and is closed by sliding first drapery shade material in a second lateral direction along the track, opposite to the first lateral direction.

39. The system of claim 38, wherein the fascia has a front plate and a bottom plate.

40. The system of claim 38, wherein the fascia has a front plate and a bottom plate, wherein the front plate and the bottom plate are approximately perpendicularly aligned to one another.

41. The system of claim 38, wherein the fascia has a front plate and a bottom plate, wherein the front plate has a generally flat front surface and the bottom plate has a generally flat bottom surface.

42. The system of claim 38, herein the fascia has a front plate and a bottom plate joined together at an intersection, wherein the track is positioned at the intersection of the front plate and the bottom plate.

43. The system of claim 38, herein the fascia has a front plate and a bottom plate, wherein the track is positioned at a lower end of the front plate and at a forward end of the bottom plate.
